(19) United States
(12) Patent Application Publication
(10) Pub. No.: US 2015/0378196 A1
(43) Pub. Date: Dec. 31, 2015

(54) LIQUID CRYSTAL DISPLAY DEVICE

(71) Applicant: Japan Display Inc., Tokyo (JP)

(72) Inventors: Takahiro OCHIAI, Tokyo (JP); Satoshi Hashimoto, Tokyo (JP); Masato Shimura, Tokyo (JP); Shunsuke Yuge, Tokyo (JP); Tomoya Sugano, Tokyo (JP)

(21) Appl. No.: 14/751,937

(22) Filed: Jun. 26, 2015

(30) Foreign Application Priority Data
Jun. 27, 2014 (JP) 2014-132401

(51) Int. Cl. G02F 1/1339; G02F 1/1337

(52) U.S. Cl. CPC G02F 1/1339; G02F 1/133723

(57) ABSTRACT

To improve the reliability of a liquid crystal display device, a liquid crystal display device includes a first substrate having a first surface, a second substrate having a second surface opposing the first surface of the first substrate, a liquid crystal layer arranged between the first substrate and the second substrate, and a sealing section that is provided along a line (a first virtual line) surrounding a periphery of the liquid crystal layer and adhesively fixes the first substrate and the second substrate. The sealing section includes a member (a first member) extending in a zigzag manner along the line and a sealing material arranged on both adjacent sides of the member and continuously surrounding a periphery of the liquid crystal layer.

### CROSS-REFERENCE TO RELATED APPLICATION

The present application claims priority from Japanese Patent Application No. 2014-132401 filed on Jun. 27, 2014, the content of which is hereby incorporated by reference into this application.

### TECHNICAL FIELD OF THE INVENTION

The present invention relates to a liquid crystal display device, for example, a technique effectively applied to a liquid crystal display device in which a pair of substrates is arranged to oppose each other and a liquid crystal layer is formed between the opposing substrates.

### BACKGROUND OF THE INVENTION

A display device, in which a display functional layer such as a liquid crystal layer is arranged between a pair of substrates arranged to oppose each other, to seal a periphery of the display functional layer, has been known.

Japanese Patent Application Laid-Open No. 2000-137234 (Patent Document 1) describes a technique for forming a seal position control pattern and a seal waving control pattern around a substrate to enhance position accuracy of an applied sealing material and reduce waving at an edge of a sealed sealing material, as a method for manufacturing a liquid crystal display device.

### SUMMARY OF THE INVENTION

A liquid crystal display device has a configuration in which a liquid crystal layer serving as a display functional layer is formed between a pair of substrates, and the pair of substrates is adhesively fixed with a sealing material in a sealing section surrounding a periphery of the liquid crystal layer, so that the liquid crystal layer is protected.

Members constituting the liquid crystal display device include a material having a high fluidity. A material used as an oriented film for aligning an orientation of a liquid crystal may include a resin material having a high fluidity such as polyimide resin upon forming a film. Therefore, if the oriented film is formed in a display region on a pair of substrates in the liquid crystal display device, the oriented film may easily spread to the periphery of the display region.

If a wide space is ensured around the display region, the oriented film and a sealing material may be prevented from overlapping each other by significantly increasing a separation distance between the display region and the sealing section. However, an attempt to reduce the area of a so-called frame section or a frame region serving as a non-display section surrounding a periphery of the display region causes the following problems.

More specifically, if the area of the frame section is reduced, the separation distance between the display region and the sealing section needs to be decreased. Therefore, when the oriented film too spreads, the oriented film remains sandwiched between the substrate and the sealing material, causing a sealing property of the sealing section to deteriorate. Thus, the pair of substrates is adhesively fixed in an insufficient manner.

A member for damping the oriented film may be provided in the frame region so as to suppress spreading of the oriented film. To reduce the area of the frame region, however, the damping member needs to be provided in the sealing section. That is, there is a region where the sealing material and the oriented film partially overlap each other. In a process for sealing the pair of substrates among processes for manufacturing the liquid crystal display device, the sealing material is applied to the sealing section, and the opposing substrates are brought closer to each other, thereby pushing out and sealing the sealing material. However, the damping member arranged in the sealing section may cause spreading of the sealing section to be inhibited.

The present invention is directed to providing a technique for improving the reliability of a display device.

A liquid crystal display device according to an aspect of the present invention includes a first substrate having a first surface, a second substrate having a second surface opposing the first surface of the first substrate, a liquid crystal layer arranged between the first substrate and the second substrate, and a sealing section that is provided along a first virtual line surrounding a periphery of the liquid crystal layer and adhesively fixes the first substrate and the second substrate. Further, the sealing section includes a first member extending in a zigzag manner along the first virtual line, and a sealing material arranged on both adjacent sides of the first member and continuously surrounding a periphery of the liquid crystal layer.

As another aspect of the present invention, the first member includes a plurality of first portions positioned on a side of the liquid crystal layer with respect to the first virtual line, and a plurality of second portions positioned on a side of a peripheral edge of the first substrate with respect to the first virtual line. The plurality of first portions and the plurality of second portions are alternately arrayed along the first virtual line.

As another aspect of the present invention, the plurality of first portions and the plurality of second portions respectively have the same shapes.

As another aspect of the present invention, the plurality of first portions and the plurality of second portions are line-symmetric with each other with the first virtual line as an axis of symmetry.

As another aspect of the present invention, the first member includes a plurality of first potions positioned on a side of the liquid crystal layer with respect to the first virtual line, and a plurality of second portions positioned on the side of a peripheral edge of the first substrate with respect to the first virtual line. The plurality of first portions and the plurality of second portions in the first member are continuously connected to each other.

As another aspect of the present invention, a center line in a width direction of the sealing section is arranged within a range of an amplitude of the first member serving as a zigzag pattern.

As another aspect of the present invention, within a range of the amplitude of a zigzag pattern formed by the first member, an area of a first region positioned on a side of the liquid crystal layer with respect to the first member and an area of a second region positioned on a side of a peripheral edge of the first substrate with respect to the first member differ from each other.

As another aspect of the present invention, the first member includes a plurality of first portions positioned on a side of the liquid crystal layer with respect to the first virtual line, and a plurality of second potions positioned on the side of a peripheral edge of the first substrate with respect to the first virtual line. A thickness of the plurality of first portions and a thickness of the plurality of second portions differ from each other.

As another aspect of the present invention, the sealing section further includes a plurality of second members formed apart from the first member. The first member includes a plurality of first portions positioned on a side of the liquid crystal layer with respect to the first virtual line, and a plurality of second portions positioned on a side of a peripheral edge of the first substrate with respect to the first virtual line. Further, the plurality of second members are formed between the plurality of second portions in the first member and a display section where the liquid crystal layer is arranged.

As another aspect of the present invention, the sealing section further includes a second member formed apart from the first member and extending in a zigzag manner along the first virtual line. Further, a center line in a width direction of the sealing section is arranged within a range of an amplitude of each of the first member serving as a zigzag pattern and the second member.

As another aspect of the present invention, an oriented film is arranged between the sealing material and the first surface of the first substrate on a side of the liquid crystal layer of the first member.

As another aspect of the present invention, the sealing section has a square shape in a plan view, and the first member extends to a corner part of the sealing section.

As another aspect of the present invention, the sealing section has a square shape in a plan view. Further, the first member includes a plurality of first portions positioned on a side of the liquid crystal layer with respect to the first virtual line, a plurality of second portions positioned on a side of a peripheral edge of the first substrate with respect to the first virtual line; and a third portion linearly extending along the first virtual line in a corner part of the sealing section.

As another aspect of the present invention, a liquid crystal display device having the following constitution is also possible. The liquid crystal display device includes a first substrate having a first surface, a second substrate having a second surface opposing the first surface of the first substrate, a liquid crystal layer arranged between the first substrate and the second substrate, and a sealing section that is provided along a first virtual line surrounding a periphery of the liquid crystal layer and adhesively fixes the first substrate and the second substrate. The sealing section includes a first member extending along the first virtual line, and a sealing material arranged on both adjacent sides of the first member and continuously surrounding the periphery of the liquid crystal layer. Further, the first member has a first side surface positioned on a side of the liquid crystal layer of the first member and inclined with respect to the first surface of the first substrate, and a second side surface positioned on an opposite side of the first side surface, and a first angle formed between the first surface of the first substrate and the first side surface is larger than a second angle formed between the first surface and the second side surface.

As another aspect of the present invention, the second angle is 45 degrees or less.

The method for manufacturing the liquid crystal display device according to an aspect of the present invention includes a step of forming a first member extending in an zigzag manner along a first virtual line on a first surface of a first substrate, and then forming an oriented film on the first surface, includes a step of forming the oriented film, and then applying a sealing material to a sealing section along the first virtual line, and includes a step of applying the sealing material, and then adhesively fixing a second substrate having a second surface opposing the first surface and the first substrate to each other by the sealing section. The sealing section is provided to surround a periphery of a display section in a plan view.

### BRIEF DESCRIPTIONS OF THE DRAWINGS

FIG. 1 is a plan view illustrating an example of a liquid crystal display device according to an embodiment;

FIG. 2 is a sectional view taken along a line A-A illustrated in FIG. 1;

FIG. 3 is an enlarged sectional view of a portion B illustrated in FIG. 2;

FIG. 4 is an enlarged sectional view of a portion C illustrated in FIG. 2;

FIG. 5 is an enlarged plan view of the portion B illustrated in FIG. 1;

FIG. 6 is an enlarged plan view successively illustrating an example of a state where a sealing material is applied to a sealing section illustrated in FIG. 5 and then spreads;

FIG. 7 is an enlarged plan view successively illustrating an example of a state where a sealing material spreads in a sealing section subsequently to FIG. 6;

FIG. 8 is an enlarged plan view successively illustrating an example of a state where a sealing material spreads in a sealing section subsequently to FIG. 7;

FIG. 9 is an enlarged plan view successively illustrating an example of a state where a sealing material spreads in a sealing section subsequently to FIG. 8;

FIG. 10 is an assembly flowchart illustrating the outline of processes for manufacturing the liquid crystal display device illustrated in FIG. 1;

FIG. 11 is an enlarged sectional view illustrating a sealing material that is applied by being discharged from a nozzle in a sealing material application process illustrated in FIG. 10;

FIG. 12 is an enlarged plan view illustrating a modification example of FIG. 5;

FIG. 13 is an enlarged plan view illustrating another modification example of FIG. 5;

FIG. 14 is an enlarged plan view illustrating another modification example of FIG. 5;

FIG. 15 is an enlarged plan view illustrating another modification example of FIG. 5;

FIG. 16 is an enlarged sectional view taken along a line A-A illustrated in FIG. 5;

FIG. 17 is an enlarged sectional view illustrating a modification example of FIG. 16;

FIG. 18 is an enlarged plan view illustrating another modification example of FIG. 5;

FIG. 19 is an enlarged plan view illustrating another modification example of FIG. 5;

FIG. 20 is an enlarged plan view illustrating another modification example of FIG. 5;

FIG. 21 is an enlarged plan view illustrating another modification example of FIG. 5;

FIG. 22 is an enlarged plan view illustrating another modification example of FIG. 5;

FIG. 23 is an enlarged sectional view taken along a line A-A illustrated in FIG. 22;

FIG. 24 is an enlarged plan view illustrating a modification example of a member for damping an oriented film illustrated in FIG. 22;

FIG. 25 is an enlarged plan view of a portion C illustrated in FIG. 1;

FIG. 26 is an enlarged plan view illustrating a modification example of FIG. 25;

FIG. 27 is an enlarged plan view illustrating another example of examination different from that illustrated in FIG. 5; and

FIG. 28 is an enlarged sectional view taken along a line A-A illustrated in FIG. 27.

### DESCRIPTIONS OF THE PREFERRED EMBODIMENTS

Hereinafter, embodiments of the present invention will be described with reference to drawings. Note that the disclosures are provided byway of example, and any suitable variations easily conceived by a person with ordinary skill in the art while pertaining to the gist of the invention are of course included in the scope of the present invention. Further, the drawings, widths, thicknesses and shapes of respective components may be schematically illustrated in comparison with the embodiments for the purpose of making the description more clearly understood, but these are merely examples, and do not limit the interpretations of the present invention. Further, in the specification and drawings, elements which are similar to those already mentioned with respect to previous drawings are denoted by the same reference characters, and detailed descriptions thereof will be suitably omitted.

The liquid crystal display device is broadly classified into two categories, described below, depending on an application direction in which an electric field for changing an orientation of liquid crystal molecules in the liquid crystal layer serving as the display functional layer. More specifically, the first category is a so-called vertical electric field mode in which an electric field is applied in a thickness direction (or an out-of-plane direction) of the liquid crystal display device. Examples of the vertical electric field mode include a Twisted Nematic (TN) mode and a Vertical Alignment (VA) mode. The second category is a so-called horizontal electric field mode in which an electric field is applied in a planar direction (or an in-plane direction) of the liquid crystal display device. Examples of the horizontal electric field mode include an In-Plane Switching (IPS) mode and a Fringe Field Switching (FFS) mode serving as one type of the IPS mode. While a technique described below is applicable to both the vertical electric field mode and the horizontal electric field mode. However, a display device in the horizontal electric field mode will be described as an example in the present embodiment.

<Basic Configuration of Liquid Crystal Display Device>

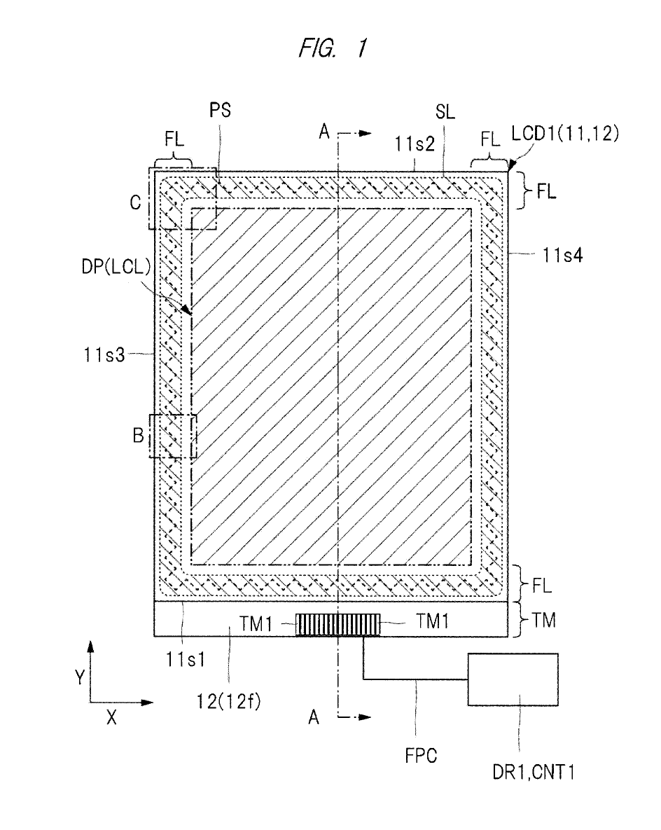

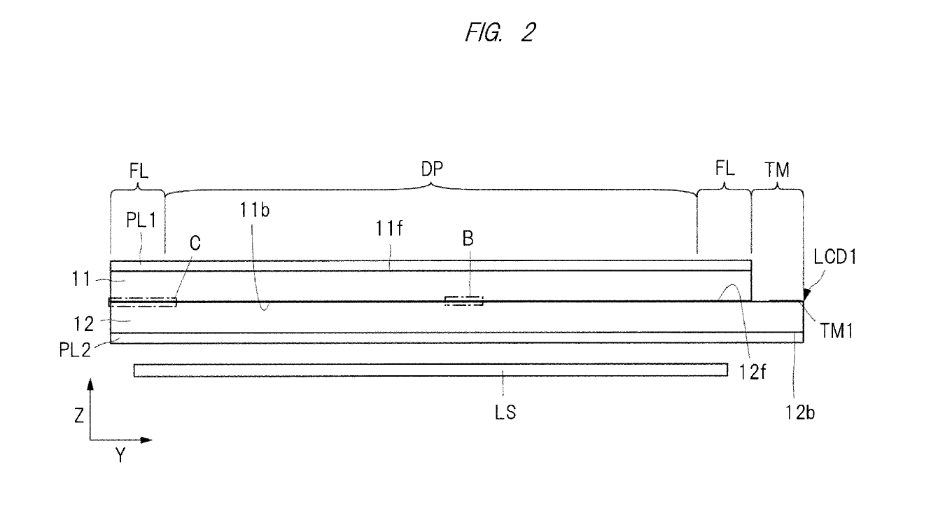

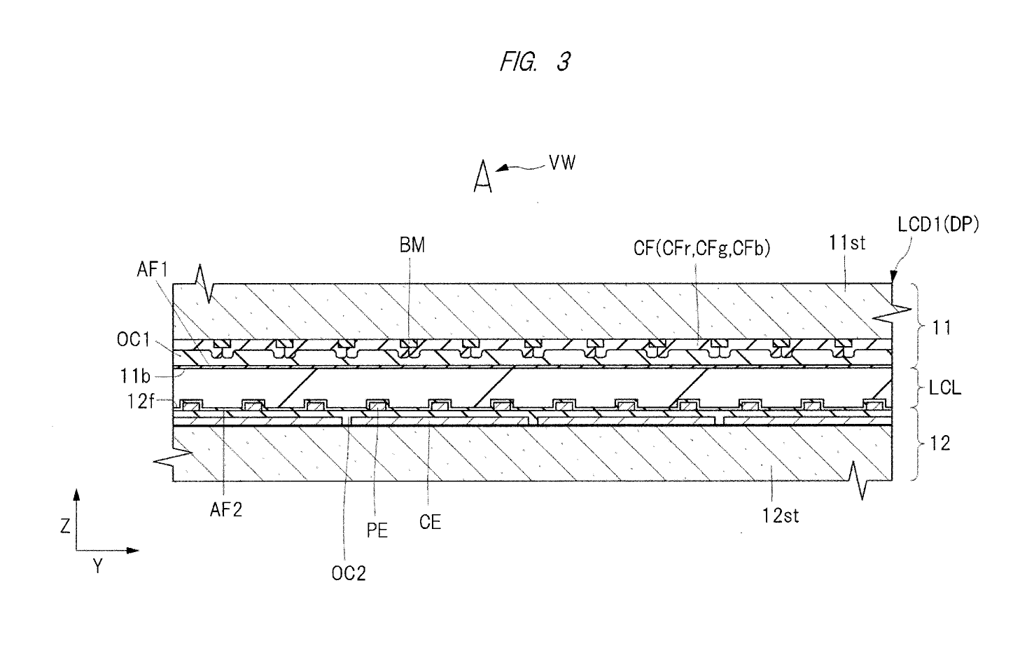

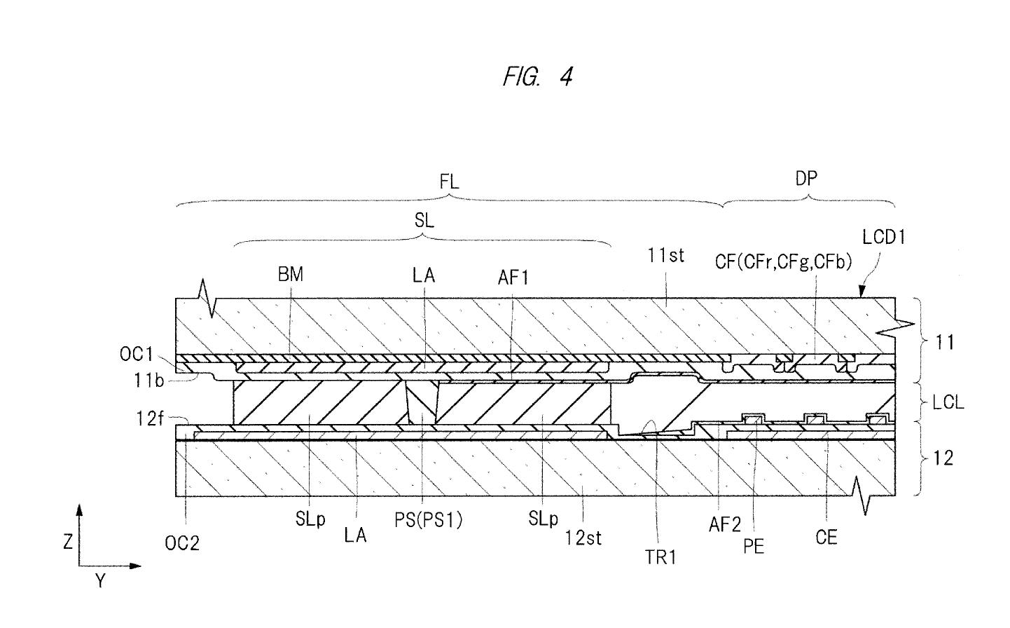

A basic configuration of a liquid crystal display device will be first described. FIG. 1 is a plan view illustrating an example of a liquid crystal display device according to the present embodiment, and FIG. 2 is a sectional view taken along a line A-A illustrated in FIG. 1. FIG. 3 is an enlarged sectional view of a portion B illustrated in FIG. 2. FIG. 4 is an enlarged sectional view of a portion C illustrated in FIG. 2.

While FIG. 1 is a plan view, a display section DP is hatched, and a contour of the display section DP is indicated by a two-dot and dash line to make a boundary between the display section DP and a frame section FL easy to see in a plan view. In FIG. 1, a sealing section SL is hatched, and a contour of the sealing section SL is indicated by a dotted line to make a planar shape of the sealing section SL provided to surround a periphery of the display section DP easy to see. In FIG. 1, to explicitly indicate a layout in a plan view of a member PS illustrated in FIG. 4, the member PS is indicated by a dotted line. While FIG. 2 is a sectional view, the hatching is omitted for ease of viewing.

As illustrated in FIG. 1, a liquid crystal display device LCD1 according to the present embodiment includes the display section DP serving as a display region where an image, which can be viewed from outside in response to an input signal, is formed. The liquid crystal display device LCD1 includes the frame section FL serving as a non-display region provided in a frame shape around the display section DP in a plan view. The liquid crystal display device LCD1 further includes a terminal section TM provided outside the frame section FL, in a plan view. In the terminal section TM, a plurality of terminals TM1 for supplying an electric signal or a voltage for driving to a plurality of elements for display formed in the display section DP, are formed.

As schematically illustrated in FIG. 1, the plurality of terminals TM1 are connected to a wiring path FPC. The wiring path FPC is a so-called flexible wiring board in which a plurality of wirings are formed in a resin film and which can be freely deformed depending on a shape of an arrangement location. The plurality of terminals TM1 are electrically connected to a driving circuit DR1 or a control circuit CM1 for image display via the wiring path FPC.

The liquid crystal display device LCD1 has a configuration in which a liquid crystal layer is formed between a pair of substrates arranged to oppose each other. More specifically, as illustrated in FIG. 2, the liquid crystal display device LCD1 includes a substrate 11 on the side of the display surface, a substrate 12 positioned on the opposite side of the substrate 11, and a liquid crystal layer LCL (see FIG. 3) arranged between the substrate 11 and the substrate 12.

The liquid crystal display device LCD1 includes the sealing section SL formed in the frame section FL around the display section DP having the liquid crystal layer LCL formed therein in a plan view, as illustrated in FIG. 1. The sealing section SL is formed to continuously surround a periphery of the display section DP, and the substrate 11 and the substrate 12 illustrated in FIG. 2 are adhesively fixed to each other with a sealing material provided in the sealing section SL illustrated in FIGS. 1 and 4. Thus, the sealing section SL is provided around the display section DP, so that the liquid crystal layer LCL formed in the display section DP and a part of the frame section FL can be sealed.

The substrate 11 illustrated in FIG. 1 has a side 11s1 extending in an X-direction, a side 11s2 opposing the side 11s1, a side 11s3 extending in a Y-direction perpendicular to the X-direction, and a side 11s4 opposing the side 11s3 in a plan view. Respective distances from the sides 11s1, 11s2, 11s3, and 11s4 of the substrate 11 illustrated in FIG. 1 to the display section DP are substantially equal. In the present application, a “peripheral edge of the substrate 11” means any one of the sides 11s1, 11s2, 11s3, and 11s4 constituting an outer edge of the substrate 11. A “peripheral edge” means a peripheral edge of the substrate 11.

As illustrated in FIG. 2, a polarizing plate PL2, which polarizes light generated from the light source LS, is provided on the side of a back surface 12b of the substrate 12 in the liquid crystal display device LCD1. The polarizing plate PL2 is adhesively fixed to the substrate 12 via an adhesive layer. On the other hand, a polarizing plate PL1 is provided on the side of a front surface 11f of the substrate 11. The polarizing plate PL1 is adhesively fixed to the substrate 11 via an adhesive layer.

While basic components for forming a display image are illustrated in FIG. 2, another component can be added in addition to the components illustrated in FIG. 2 as a modification example. For example, a protective film or a cover member may be attached to the side of the front surface of the polarizing plate PL1 as a protective layer for protecting the polarizing plate PL1 from a flaw or dirt. For example, the present invention is applicable to an example in which an optical film such as a phase difference plate is affixed to the polarizing plate PL1 and the polarizing plate PL2. Alternatively, a method for forming the optical film is applicable to each of the substrate 11 and the substrate 12. As a modification example of FIG. 1, a semiconductor chip in which a driving circuit for supplying a pixel voltage to a pixel electrode PE (see FIG. 3) is formed, for example, may be mounted on a front surface 12f of the substrate 12. A system for mounting a semiconductor chip on a glass substrate is referred to as a Chip on glass (COG) system. A part of the driving circuit may be formed in the frame region using an element simultaneously formed when an element for display is formed.

As illustrated in FIG. 3, the liquid crystal display device LCD1 includes a plurality of pixel electrodes PE arranged between the substrate 11 and the substrate 12 and a common electrode CE arranged between the substrates 11 and 12. The liquid crystal display device LCD1 according to the present embodiment is the display device in the horizontal electric field mode, as described above. Thus, each of the plurality of pixel electrode PE and the common electrodes CE is formed in the substrate 12.

In the substrate 12 illustrated in FIG. 3, a circuit mainly for image display is formed in a base material 12st composed of a glass substrate, etc. The substrate 12 includes the front surface 12f positioned on the side of the substrate 11 and a back surface 12b (see FIG. 2) positioned on the opposite side thereof. An active element such as a Thin-Film Transistor (TFT) and the plurality of pixel electrodes PE are formed in a matrix shape on the side of the front surface 12f of the substrate 12. A substrate where the TFT is formed as an active element, e.g., the substrate 12 is referred to as a TFT substrate.

An example illustrated in FIG. 3 illustrates the liquid crystal display device LCD1 in the horizontal electric field mode (specifically, an FFS mode), as described above. Thus, each of the common electrode CE and the pixel electrodes PE is formed on the side of the front surface 12f of the substrate 12. The common electrode CE is formed on the side of a front surface of the base material 12st in the substrate 12, and is covered with an insulating layer OC2. The plurality of pixel electrodes PE are formed in the insulating layer OC2 on the side of the substrate 11 so as to oppose the common electrode CE via the insulating layer OC2.

The substrate 11 illustrated in FIG. 3 is a substrate in which a color filter CF, which forms an image for color display, is formed in a base material 11st composed of a glass substrate, etc. and has the front surface 11f (see FIG. 2) on the side of the display surface and a back surface 11b positioned on the opposite side of the front surface 11f. The substrate having the color filter CF formed therein, e.g., the substrate 11 is referred to as an opposite substrate because it opposes the above-described TFT substrate via a color filter substrate or a liquid crystal layer when distinguished from the TFT substrate. As a modification example of FIG. 3, a configuration in which the color filter CF is provided in the TFT substrate can also be used.

In the substrate 11, the color filter CF having color filter pixels CFr, CFg, and CFb in three colors, i.e., red (R), green (G), and blue (B) periodically arranged therein is formed on one surface of the base material 11st such as a glass substrate. In a color display device, sub-pixels in three colors, i.e., red (R), green (G), and blue (B) are used as one set, to constitute one pixel, for example. The plurality of color filter pixels CFr, CFg, and CFb in the substrate 11 are arranged at positions opposing respective sub-pixels having the pixel electrodes PE formed in the substrate 12.

Light shielding films BM are respectively formed in boundaries among the color filter pixels CFr, CFg, and CFb in the colors R, G, and B. The light shielding film BM is referred to as a black matrix, and is composed of black resin, for example. The light shielding film BM is formed in a lattice shape in a plan view. In other words, the substrate 11 includes the color filter pixels CFr, CFg, and CFb in the colors R, G, and B formed among the light shielding films BM formed in a lattice shape.

In the present application, the display section DP or the region described as the display region is defined as a region positioned inside with respect to the frame section FL. The frame section FL is a region covered with the light shielding film BM that shields the light irradiated from the light source LS illustrated in FIG. 2. The light shielding film BM is also formed within the display section DP. However, in the display section DP, a plurality of openings are formed in the light shielding film BM. Generally, an end of the opening formed on the side of the most peripheral edge of the display section DP among the openings formed in the light shielding film BM and in which the color filter CF is embedded is defined as a boundary between the display section DP and the frame section FL.

The substrate 11 has a resin layer OC1 covering the color filter CF. The light shielding films BM are respectively formed in the boundaries among the color filter pixels CFr, CFg, and CFb in the colors R, G, and B. Thus, an inner side surface of the color filter CF is an uneven surface. The resin layer OC1 functions as a flattening film for flattening the unevenness on the inner side surface of the color filter CF. Alternatively, the resin layer OC1 functions as a protective film for preventing impurities from being diffused into the liquid crystal layer from the color filter CF. The resin layer OC1 can harden a resin material by containing a component to be hardened by applying energy, i.e., a thermosetting resin component or a light hardening resin component in its material.

A liquid crystal layer LCL, in which a display image is formed when a voltage for display is applied between the pixel electrodes PE and the common electrode CE, is provided between the substrate 11 and the substrate 12. The liquid crystal layer LCL modulates light that passes therethrough depending on a state of an applied electric field.

The substrate 11 includes an oriented film AF1 covering the resin layer OC1 on the back surface 11b serving as an interface contacting the liquid crystal layer LCL. The substrate 12 has an oriented film AF2 covering an insulating layer OC2 and the plurality of pixel electrodes PE on the front surface 12f serving as an interface contacting the liquid crystal layer LCL. The oriented films AF1 and AF2 are resin films formed to make initial orientations of liquid crystals included in the liquid crystal layer LCL align, and are composed of polyimide resin, for example.

As illustrated in FIG. 4, the sealing section SL arranged to surround the liquid crystal layer LCL includes a sealing material SLp. The liquid crystal layer LCL is sealed into a region surrounded by the sealing material SLp. That is, the sealing material SLp functions as a sealing material for preventing the liquid crystal layer LCL from leaking out. The sealing material SLp adheres to each of the back surface 11b of the substrate 11 and the front surface 12f of the substrate 12. The substrate 11 and the substrate 12 are adhesively fixed to each other via the sealing material SLp. That is, the sealing material SLp functions as an adhesive member for adhesively fixing the substrates 11 and 12 to each other.

The thickness of the liquid crystal layer LCL illustrated in FIGS. 3 and 4 is significantly smaller than the thicknesses of the substrates 11 and 12. For example, the thickness of the liquid crystal layer LCL is approximately 0.1% to 10% of the thicknesses of the substrates 11 and 12. In an example illustrated in FIGS. 3 and 4, the thickness of the liquid crystal layer LCL is, for example, approximately 3 μm to 4 μm.

In the present embodiment, the sealing section SL includes a member PS arranged around the liquid crystal layer LCL and extending along an outer edge of the liquid crystal layer LCL, as illustrated in FIGS. 1 and 4. The member PS illustrated in FIGS. 1 and 4 can be formed in one or both of the substrates 11 and 12. An example in which the member PS is formed in the substrate 11 will be described below as a representative example.

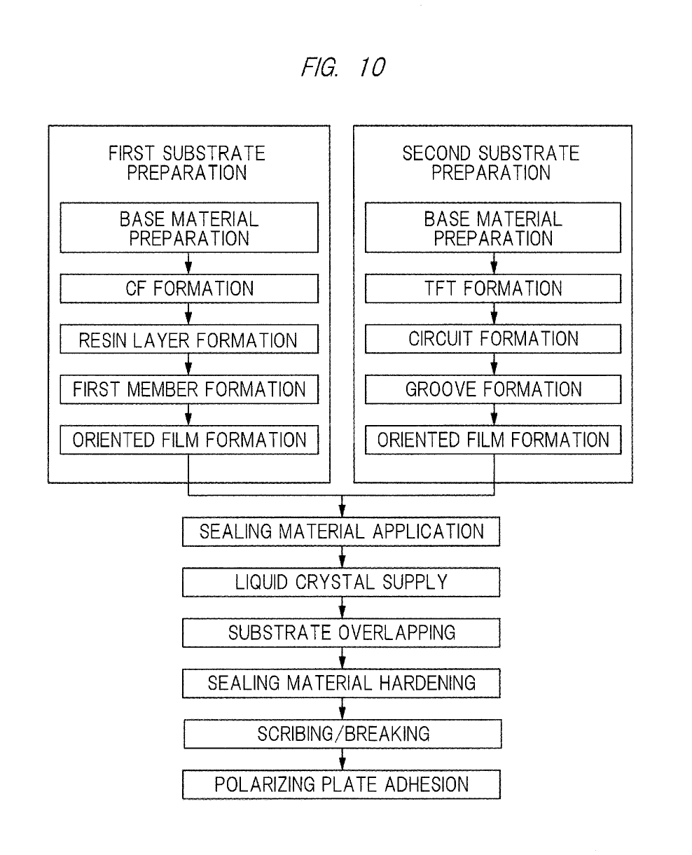

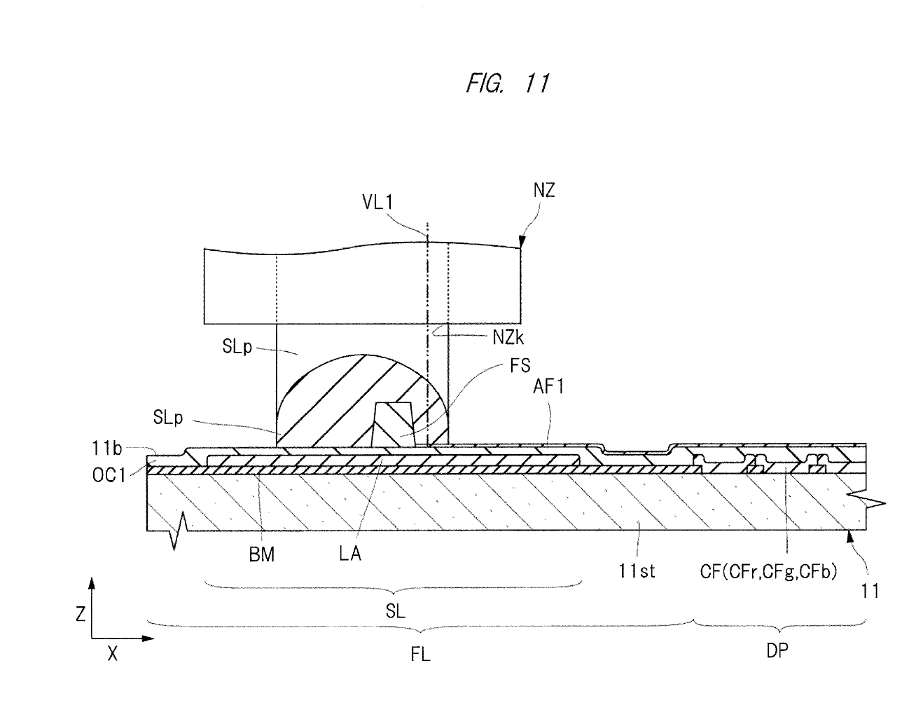

The member PS functions as a damping member for suppressing spreading of the oriented film AF1 to a peripheral edge of the substrate 11 when the oriented film AF1 is formed on the back surface 11b of the substrate 11 in processes for manufacturing the liquid crystal display device LCD1. Thus, the member PS is a projecting (convex-shaped) member formed so as to project toward the back surface 11b illustrated in FIG. 11.

If the oriented film AF1 spreads to the peripheral edge on the back surface 11b of the substrate 11, the back surface 11b including the sealing section SL is covered with the oriented film AF1. In this case, the sealing material SLp does not adhere to the back surface 11b of the substrate 11. This causes a sealing property such as adhesive strength of the sealing section SL or airtightness of a region inside the sealing section SL to decrease. The adhesive strength of the sealing section SL, i.e., sealing strength in the sealing section SL will be described in detail below.

The oriented film AF1 is composed of a resin material having high fluidity such as polyimide resin, as described above. Therefore, unless a portion for damping is formed around the display region, the oriented film AF1 easily spreads to a wide range.

Accordingly, in the present embodiment, the member PS arranged around the liquid crystal layer LCL and extending along an outer edge of the liquid crystal layer LCL is formed as a damping member suppressing the spreading of the oriented film AF1 to the peripheral edge. Thus, the member PS damps the oriented film AF1. That is, the spreading of the oriented film AF1 to the outer side of the member PS (the side of the peripheral edge) can be suppressed. The height of the member PS, i.e., the length in a Z-direction (thickness direction) toward the substrate 12 from the back surface 11b of the substrate 11 illustrated in FIG. 4 is approximately 3 μm to 4 μm, for example.

In an example illustrated in FIG. 4, the member PS also functions as a spacer member for defining a separation distance between the substrate 11 and the substrate 12 in the sealing section SL. Thus, the member PS contacts both the back surface 11b of the substrate 11 and the front surface 12f of the substrate 12. In the example illustrated in FIG. 4, the member PS is formed so as to project toward the substrate 12 from the back surface 11b of the substrate 11, and a leading end of its projecting part contacts the front surface 12f of the substrate 12.

However, a method for defining the separation distance between the substrate 11 and the substrate 12 includes various modification examples in addition to the foregoing method, for example, a method for mixing a glass fiber with the sealing material SLp and defining the separation distance between the substrate 11 and the substrate 12 depending on the thickness of the glass fiber. In this case, the thickness of the member PS may be made smaller than the separation distance between the substrate 11 and the substrate 12.

In the present embodiment, the member PS is formed in the sealing section SL to reduce the area of the frame section FL. More specifically, a part of the sealing material SLp overlaps a peripheral edge of the oriented film AF1 in a thickness direction inside the member PS, i.e., on the side of the display section DP with respect to the member PS, as illustrated in FIG. 4. On the other hand, the substrate 11 does not spread to the outer side of the member PS, i.e., the oriented film AF1 does not spread to the side of the peripheral edge of the substrate 11. Thus, the other part of the sealing material SLp does not overlap the peripheral edge of the oriented film AF1 but adheres to the resin layer OC1 having the back surface 11b of the substrate 11 outside the member PS, i.e., on the side of the peripheral edge of the substrate 11.

A method for displaying a color image by the liquid crystal display device LCD1 illustrated in FIG. 3 is as follows, for example. More specifically, light emitted from the light source LS is filtered by the polarizing plate PL2, and light passing through the polarizing plate PL2 is incident on the liquid crystal layer LCL. The light incident on the liquid crystal layer LCL is propagated in the thickness direction of the liquid crystal layer LCL (i.e., a direction directed toward the substrate 11 from the substrate 12) by changing a polarization state depending on refractive index anisotropy of a liquid crystal (i.e., birefringence), and is emitted from the substrate 11. At this time, liquid crystal orientation is controlled by an electric field formed by applying a voltage to the pixel electrodes PE and the common electrode CE, and the liquid crystal layer LCL functions as an optical shutter. That is, in the liquid crystal layer LCL, light transmissivity can be controlled for each sub-pixel. Light, which has reached the substrate 11, is subjected to color filtering processing (i.e., processing for absorbing light other than that having a predetermined wavelength) in the color filter CF formed in the substrate 11, and is emitted from the front surface 11f. The light emitted from the front surface 11f reaches a viewer VW via the polarizing plate PL1.

<Details of Sealing Section>

Details of the sealing section SL illustrated in FIG. 4 will be described below. In this section, a relationship between the sealing strength in the sealing section SL and the member PS will be described. In this section, the effect of a position of the member PS in the sealing section SL on control of a separation distance between the substrate 11 and the substrate 12 will also be described.

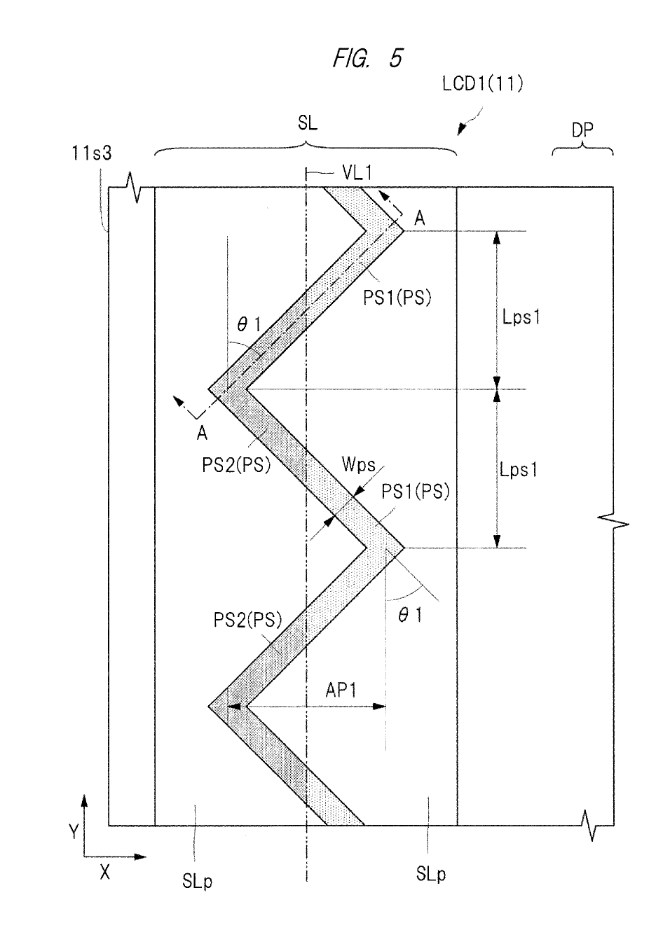

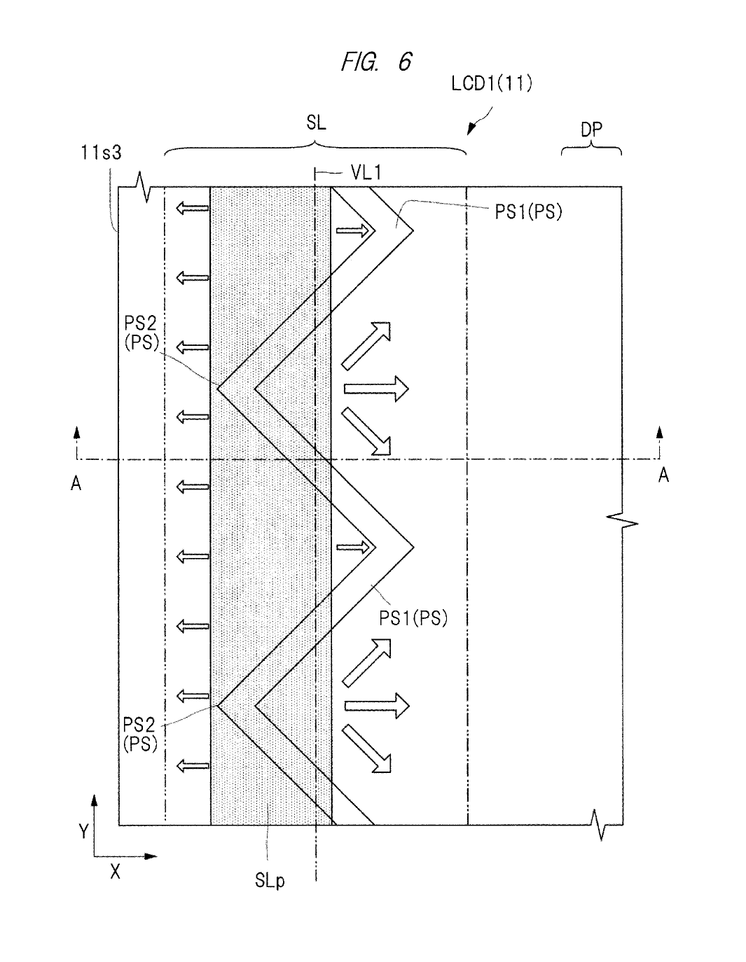

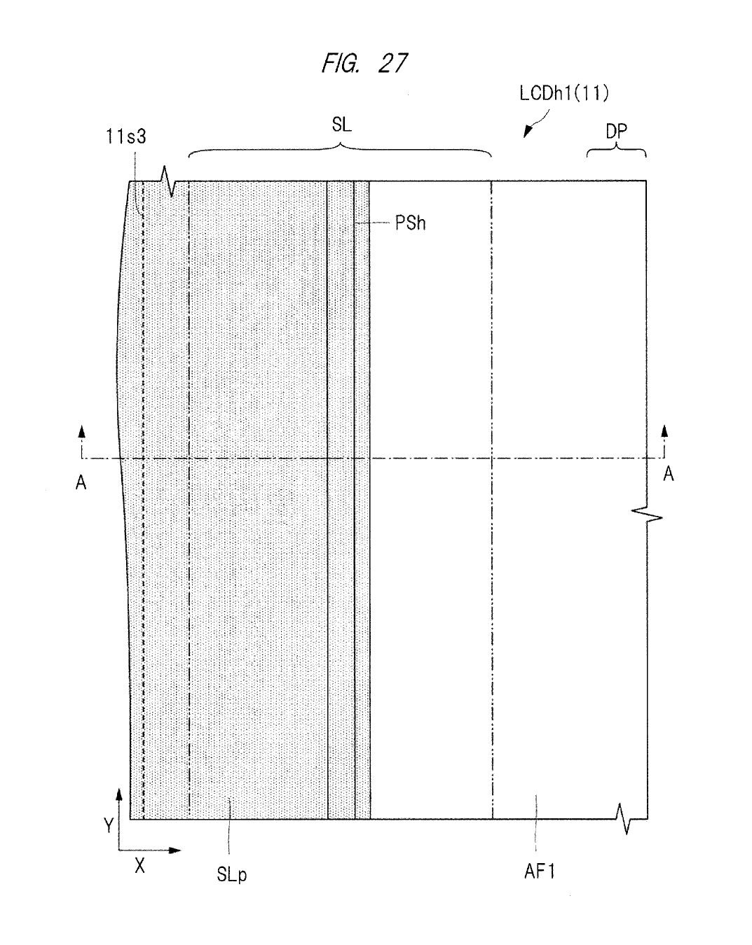

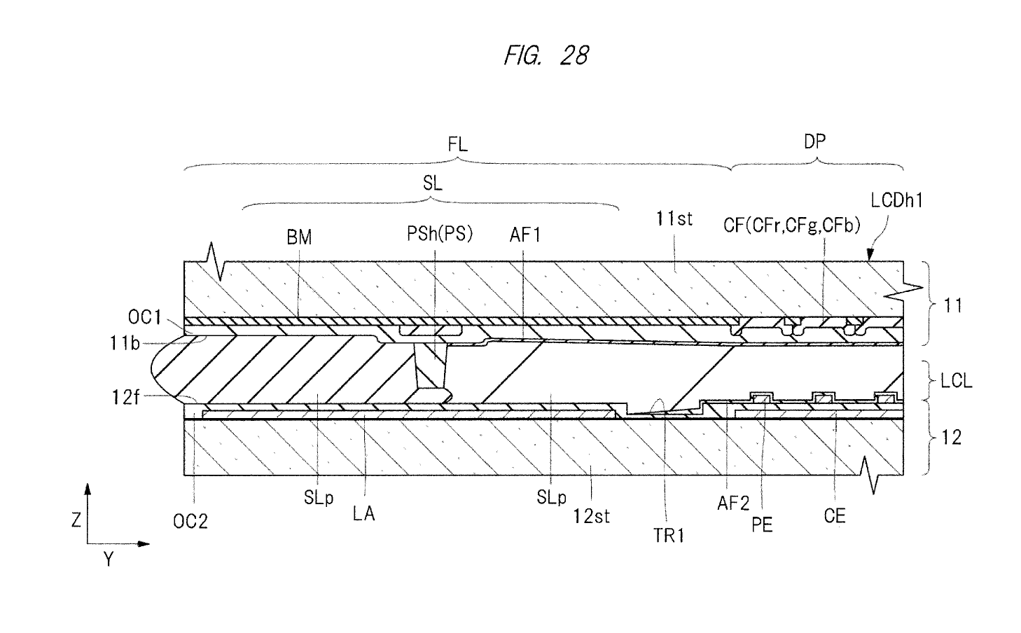

FIG. 5 is an enlarged plan view of the portion B illustrated in FIG. 1. FIG. 27 is an enlarged plan view illustrating another example of examination from that illustrated in FIG. 5, and FIG. 28 is an enlarged sectional view taken along a line A-A illustrated in FIG. 27. FIGS. 6 to 9 are enlarged plan views successively illustrating an example of a state where a sealing material is applied to a sealing section illustrated in FIG. 5 and then spreads.

FIG. 5 is an enlarged plan view of the member PS formed on the substrate 11 illustrated in FIG. 4 as viewed from the substrate 12. The member PS illustrated in FIG. 5 is a member arranged between the substrate 11 and the substrate 12 illustrated in FIG. 4. However, to explicitly indicate a planar position of the member PS, the member PS is indicated by a solid line and is given a dot pattern in FIG. 5. In FIG. 5, a line VL1 serving as a virtual line extending in a direction in which the sealing section SL extends and a region of the sealing section SL are indicated by a two-dot and dash line. In FIG. 5, a portion PS1 on the side of the display section DP with respect to the line VL1 and a portion PS2 of the peripheral edge of the substrate 11 with respect to the line VL1 are respectively assigned different types of dot patterns to make it easy to see the portion PS1 and the portion PS2.

In FIGS. 6 to 9, the sealing material SLp is assigned a dot pattern to make a state where the sealing material SLp spreads understandable. In a method for manufacturing the liquid crystal display device, a plurality of devices may be formed in a large-sized substrate and then individuated later. In this case, in a process for the sealing material SLp to fluidly move, the peripheral edge of the substrate 11 may not be cut, as illustrated in FIGS. 6 to 9. However, in FIGS. 6 to 9, to explicitly indicate a positional relationship between the peripheral edge of the substrate 11 and the sealing material SLp, the side 11s3 illustrated in FIG. 5 is indicated by a solid line. Therefore, the side 11s3 illustrated in FIGS. 6 to 9 can be taken as a boundary line of a cutting scheduled region. In FIG. 6, a direction in which the sealing material SLp spreads is indicated by arrows.

First, the sealing strength in the sealing section SL illustrated in FIG. 4 is defined by adhesive strength between each of the substrate 11 and the substrate 12, and the sealing material SLp. In the example illustrated in FIG. 4, each of adhesive strength between the sealing material SLp and the oriented film AF1 and adhesive strength between the oriented film AF1 and the resin layer OC1 is lower than adhesive strength between the sealing material SLp and the resin layer OC1. Similarly, each of adhesive strength between the sealing material SLp and the oriented film AF2 and adhesive strength between the oriented film AF2 and the insulating layer OC2 is lower than adhesive strength between the sealing material SLp and the insulating layer OC2.

Therefore, an adhesion area between the sealing material SLp and the resin layer OC1 is preferably increased from the viewpoint of improving adhesive strength between the substrate 11 and the sealing material SLp. An adhesion area between the sealing material SLp and the insulating layer OC2 is preferably increased from the viewpoint of improving adhesive strength between the substrate 12 and the sealing material SLp.

The oriented films AF1 and AF2 are composed of a material having a high fluidity such as polyimide resin. Thus, the oriented films AF1 and AF2 easily spread to the periphery of the display section DP when formed to cover the entire display section DP. Therefore, a damping member PS is preferably provided between the sealing section SL and the display section DP, from the viewpoint of increasing an adhesive area between the sealing material SLp and the insulating layer OC1.

An approach to reducing the area of the frame section FL provided around an effective display region has been recently examined from the viewpoint of improving the design of the display device, miniaturizing the display device, or making the display device lightweight. That is, there is a request for a technique for reducing the area of the frame section FL illustrated in FIG. 1 and increasing an area occupied by the display section DP in a plan view.

As illustrated in FIG. 1, the sealing section SL is formed in the frame section FL. If the area of the frame section FL decreases, therefore, a distance between the sealing section SL and the display section DP decreases. The oriented film AF1 and the oriented film AF2 illustrated in FIG. 4 need to spread to the entire display section DP. If the distance between the sealing section SL and the display section DP decreases, therefore, the member PS is arranged in the sealing section SL.

In a liquid crystal display device LCDh1 illustrated in FIG. 27, for example, a member PSh linearly extending in a direction in which a sealing section SL extends is formed in the sealing section SL. In this case, an oriented film AF1 spreads toward the outside of the display section DP, and is damped by the member PSh. Thus, the oriented film AF1 does not spread between a peripheral edge of a substrate 11 and the member PSh. In this way, the member PSh has a function of damping the oriented film AF1 and controlling the spreading of the oriented film AF1.

When the material PSh for damping the oriented film is provided in the sealing section SL, however, the damping member PSh inhibits the sealing material SLp from spreading when the sealing material SLp is pushed out in processes for manufacturing the liquid crystal display device LCDh1.

When the sealing material SLp as illustrated in FIG. 4 is formed, the paste-shaped sealing material SLp is applied onto the sealing section SL in the substrate 11, for example, so that the distance between the substrate 11 and the substrate 12 is decreased, to push out the sealing material SLp. At this time, an application position may shift to a part other than the center in the width direction of the sealing section SL due to accuracy in application work of the sealing material SLp. FIG. 27 illustrates an example in which the application position of the sealing material SLp has shifted toward the peripheral edge of the substrate 11 with respect to the member PSh.

In an example illustrated in FIG. 27, the member PSh inhibits the sealing material SLp from spreading, so that the sealing material SLp does not spread toward the display section DP with respect to the member PSh. In this case, the thickness of the sealing material SLp increases, as illustrated in FIG. 28. As a result, the separation distance between the substrate 11 and the substrate 12 varies depending on the degree of the thickness of the sealing material SLp. Therefore, the thickness of the liquid crystal layer LCL is difficult to control.

In this way, if the thickness of the liquid crystal layer LCL is not stabilized and becomes non-uniform in a plan view, positions of the color filter CF and the pixel electrodes PE may deviate from each other. When the sealing material SLp insufficiently spreads, an adhesion area between the sealing material SLp and the substrate 11 or between the sealing material SLp and the substrate 12 may decrease.

In the example illustrated in FIG. 27, a part, which has been unable to get over the member PSh, of the sealing material SLp spreads toward the peripheral edge of the substrate 11. In this case, as illustrated in FIG. 28, a part of the sealing material SLp may project outward beyond peripheral edges of the substrate 11 and the substrate 12. As described above, a method for manufacturing the liquid crystal display device LCDh1 may include a process for cutting the peripheral edges of the substrate 11 and the substrate 12. In this case, the existence of the sealing material SLp in a cutting region may cause a malfunction during cutting.

When an application position of the sealing material SLp shifts toward the display section DP with respect to the member PSh, although illustration is omitted, a part, which has been unable to get over the member PSh, of the sealing material SLp may spread toward the display section DP.

The inventors of the present application have examined a technique capable of stably spreading the sealing material SLp even when the member PS for damping the oriented film AF1 is arranged in the sealing section SL, and have found out a configuration of the liquid crystal display device LCD1 described in the present embodiment.

More specifically, the liquid crystal display device LCD1 according to the present embodiment includes the sealing section SL extending along the line VL1 serving as the virtual line, as illustrated in FIG. 5. The sealing section SL includes the member PS extending in a zigzag manner along the line VL1. If represented in another viewpoint, the member PS included in the liquid crystal display device LCD1 according to the present embodiment meanders with respect to the line VL1 in the direction in which the sealing section SL extends. If represented in still another viewpoint, the member PS included in the liquid crystal display device LCD1 according to the present embodiment forms a wave shape along the line VL1 in the direction in which the sealing section SL extends in a plan view.

When the member PS is extended in a zigzag manner along the line VL1, like in the present embodiment, the following effect is obtained. More specifically, if the member PS has a zigzag shape, even when the sealing material SLp is applied to a position off the center in the width direction of the sealing section SL, like in an example illustrated in FIG. 6, a part of the sealing material SLp is easily applied to a part, on the side of the display section DP, of the member PS. In other words, if the member PS has a zigzag shape, a part of the sealing material SLp is applied to a position on the side of the display section DP with respect to the member PS and another part of the sealing material SLp is applied to a position on the side of the peripheral edge with respect to the member PS at the time point where the sealing material SLp is applied. When the sealing material SLp is applied to stride over the member PS, as illustrated in FIG. 6, the sealing material SLp easily spreads across the member PS.

In the example illustrated in FIG. 6, for example, the sealing material SLp applied to the position on the side of the display section DP with respect to the member PS easily spreads to a region sandwiched between the adjacent portions PS1. On the other hand, the member PS damps the sealing material SLp applied to the position on the side of the display section DP with respect to the member PS. However, in the example illustrated in FIG. 6, a part, which has been damped by the member PS, of the sealing material SLp is pulled by a portion spreading to a space sandwiched between the adjacent portions PS1, to easily get over the member PS.

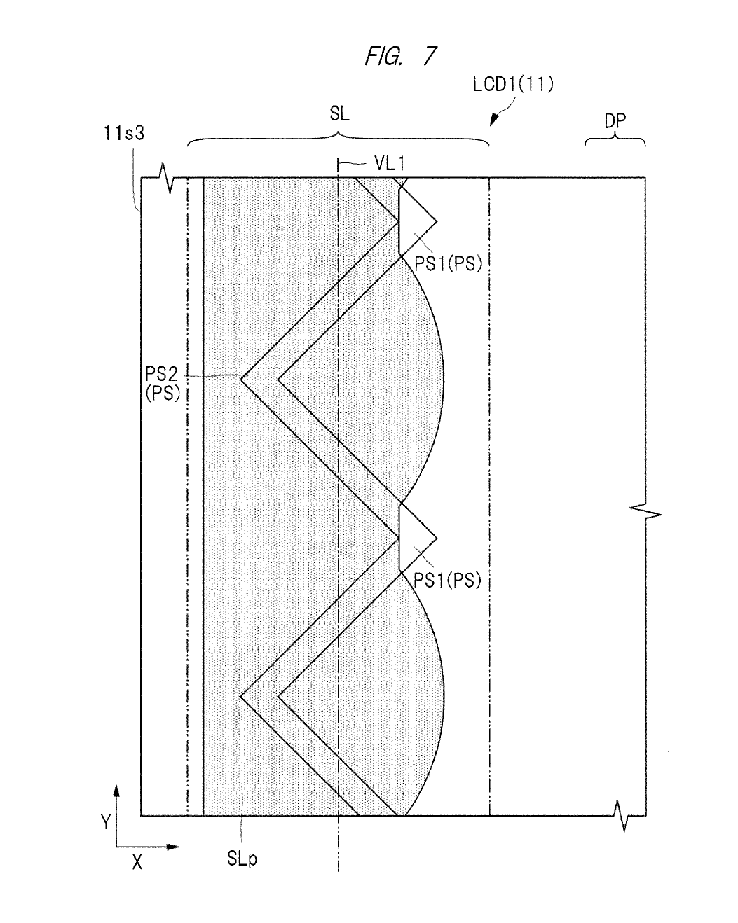

In the example illustrated in FIG. 6, the sealing material SLp successively spreads, as illustrated in FIGS. 6 to 9, when an example of a state where the sealing material SLp spreads is illustrated. First, the sealing material SLp previously spreads to the space sandwiched between the adjacent portions PS1, as illustrated in FIG. 7. At this time, the portion PS1 inhibits the applied part, on the side of the peripheral edge with respect to the portion PS1 in the member PS, of the sealing material SLp from spreading, so that a spreading speed is reduced.

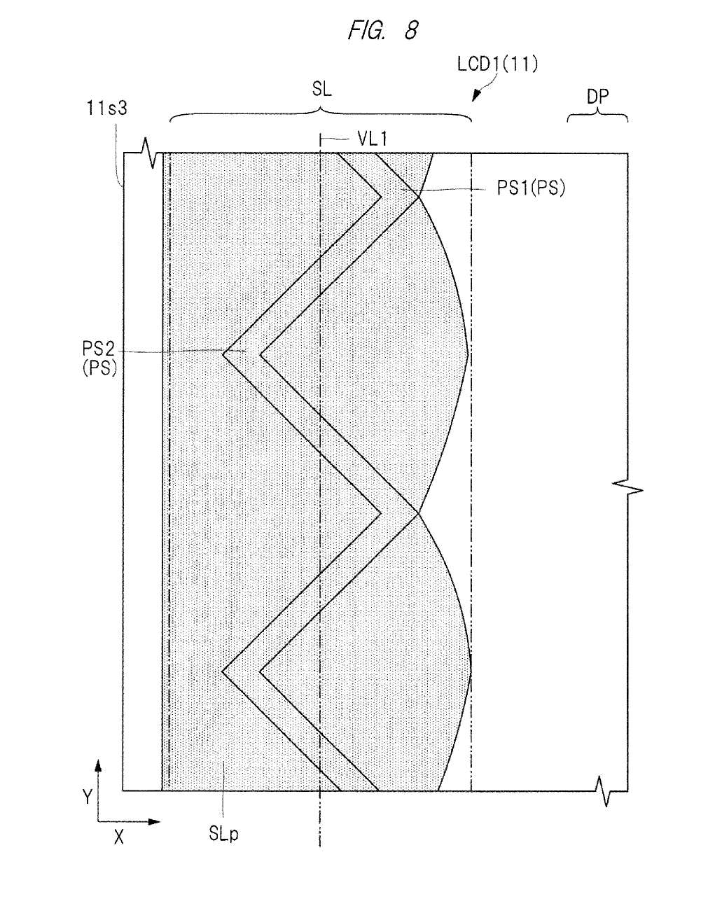

However, the paste-shaped sealing material SLp has fluidity. If a part of the sealing material SLp spreads toward the display section DP, the other part is pulled toward the display section DP. Thus, as illustrated in FIG. 8, the other part spreads toward the display section DP by getting over the portion PS1 in the member PS. In other words, when the sealing material SLp applied to a position getting over the member PS exists in a stage where the sealing material SLp is applied, a part, getting over the member PS, of the sealing material SLp spreads, so that the entire sealing material SLp easily gets over the portion PS.

Particularly, as illustrated in FIG. 7, both adjacent sides of the part, which is inhibited from spreading by the portion PS1, of the sealing material SLp spread toward the display section DP, the sealing material SLp easily spread toward the display section DP by getting over the portion PS1, as illustrated in FIG. 8.

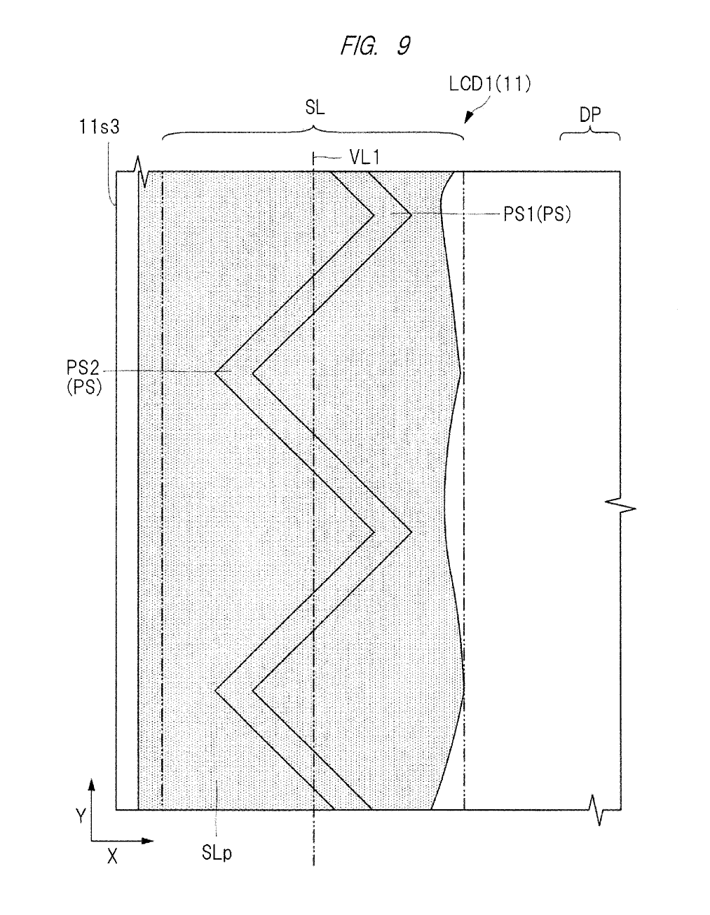

After the sealing material SLp gets over both the portion PS1 and the portion PS2 in the member PS, the sealing material SLp spreads toward both the adjacent sides of the member PS, as illustrated in FIG. 9. In the present embodiment, the member PS also functions as a spacer member for defining the separation distance between the substrate 11 and the substrate 12. Thus, as illustrated in FIG. 4, the member PS contacts both the back surface 11b of the substrate 11 and the front surface 12f of the substrate 12. Therefore, at the time point where the member PS contacts the front surface 12f of the substrate 12, the sealing material SLp is arranged on both the adjacent sides of the member PS. At this time, the sealing material SLp adheres to both side surfaces of the member PS, as illustrated in FIG. 4, in a sectional view in a direction perpendicular to the direction in which the member PS extends.

As described above, according to the present embodiment, if the planar shape of the member PS is a zigzag pattern, even when the sealing material SLp is applied to a position off the center in the width direction of the sealing section SL, like in the example illustrated in FIG. 6, the sealing material SLp easily spreads across the member PS. That is, even if accuracy in the application position of the sealing material SLp varies, the sealing material SLp can spread in a balanced manner to both the adjacent sides of the member PS.

Therefore, according to the present embodiment, even when the member PS for damping the oriented film is provided in the sealing section SL, a range in which the sealing material SLp spreads can be controlled. Thus, excessive spreading of the sealing material SLp toward the peripheral edge of the substrate 11 and the display section DP can be suppressed. Alternatively, according to the present embodiment, even when the member PS for damping the oriented film is provided in the sealing section SL, a variation in the thickness of the sealing material SLp can be suppressed.

As illustrated in FIG. 5, the member PS in the present embodiment includes the plurality of portions PS1 positioned on the side of the display section DP (i.e., on the side of the liquid crystal layer LCL (see FIG. 4)) with respect to the line VL1 and the plurality of portions PS2 positioned on the side of the peripheral edge of the substrate 11 with respect to the line VL1. The plurality of portions PS1 and the plurality of portions PS2 are alternately arrayed along the line VL1. When the sealing material SLp spreads, therefore, a state where both the adjacent sides of the part, which is inhibited from spreading by the portion PS1, of the sealing material SLp spread toward the display section DP is easy to implement, as illustrated in FIG. 7.

In the example illustrated in FIG. 5, a planar shape of the member PS is a triangular wave shape in which the portions PS1 and the portions PS2, which are line-symmetric with each other, are alternately and continuously arranged with the line VL1 as an axis of symmetry. In the example illustrated in FIG. 5, a width Wps of the member PS is 7 μm. An amplitude AP1 of the zigzag pattern is 200 μm with a center line of the member PS used as a basis. Angles θ1 formed between linear parts of the member PS with respect to the direction in which the sealing section SL extends are respectively 45 degrees. Spacings LPs1 between vertices of the portion PS1 and vertices of the portion PS2 in the direction in which the sealing section SL extends are respectively 200 μm.

<Method for Manufacturing Liquid Crystal Display Device>

A method for manufacturing the liquid crystal display device described in the present embodiment will be described below. FIG. 10 is an assembly flowchart illustrating the outline of the processes for manufacturing the liquid crystal display device illustrated in FIG. 1. Members referred to in the following description will be described in detail by referring to FIGS. 1 to 9, described above, as needed.

As illustrated in FIG. 10, the method for manufacturing the display device according to the present embodiment includes a first substrate preparation process for preparing the substrate 11 illustrated in FIG. 3 and a second substrate preparation process for preparing the substrate 12 illustrated in FIG. 3. The method of manufacturing the display device according to the present embodiment includes a sealing material application process, a liquid crystal supply process, a substrate overlapping process, a sealing material hardening process, and a scribing/breaking process.

In the first substrate preparation process illustrated in FIG. 10, the opposite substrate corresponding to the substrate 11 illustrated in FIGS. 3 and 4 is prepared. In the first substrate preparation process, the base material 11st composed of a glass substrate, for example, is prepared (a base material preparation process). After the base material preparation process, the light shielding film BM and the plurality of color filters CF are formed on one surface of the base material 11st (a CF formation process). The light shielding film BM is also formed in not only the display section DP, in but also the frame section FL, as illustrated in FIG. 4. In this process, a member LA may be further formed on the light shielding film BM at a position, which overlaps the member PS in the thickness direction, of the sealing section SL, as illustrated in FIG. 4. The member LA is a height adjustment member for adjusting the height of the resin layer OC1 at a position where the member PS is formed. The member LA can be formed of the same resin material as that of the color filter CF, for example.

After the CF formation process, the resin layer OC1 is formed to cover the plurality of color filters CF (a resin layer formation process). The color filters CF and the light shielding film BM are covered with the resin layer OC1, so that the color filters CF and the light shielding film BM are protected. When the resin layer OC1 is formed to cover the color filters CF, the back surface 11b of the substrate 11 can be flattened.

After the resin layer formation process, the member PS is formed (a first member formation process). In this process, the member PS is patterned to extend in a zigzag manner in the direction in which the sealing section SL extends, as described with reference to FIGS. 5 to 9. The member PS can be formed in a photolithography process including an exposure process and a removal process for chemically removing its unnecessary part, like the color filter CF and the light shielding film BM.

Within the display section DP illustrated in FIG. 4, to suppress excessive decrease in the separation distance between the substrate 11 and the substrate 12, a plurality of spacer members may be formed between the substrate 11 and the substrate 12 in the display section DP. The plurality of spacer members can be formed integrally with the member PS in the first member formation process illustrated in FIG. 10.

After the first member formation process, the oriented film AF1 is formed on the side of the back surface 11b of the substrate 11 (a oriented film formation process). In the oriented film formation process, after polyimide resin serving as a raw material for the oriented film AF1, for example, is applied, the oriented film AF1 can be formed by rubbing processing. The rubbing processing may be replaced with a photo-alignment method for irradiating a polymer film with ultraviolet rays and selectively reacting a polymer chain in a polarization direction to form the oriented film AF1.

A method for applying the polyimide resin can include a screen printing system or an inkjet system, for example. If the polyimide resin is applied using the inkjet system, the oriented film AF1 more easily spreads therearound than using the screen printing system. However, according to the present embodiment, the member PS is formed to surround the periphery of the display section DP, as illustrated in FIG. 1, before the oriented film formation process. Thus, spreading of the oriented film AF1 to the outer side of the member PS can be suppressed.

In the oriented film formation process, the oriented film AF1 spreads into a region surrounded by the member PS, and is damped by the member PS. In other words, the oriented film formation process includes a process for damping the spreading of the oriented film AF1 by the member PS, so that the peripheral edge of the oriented film AF1 after the oriented film formation process contacts the member PS, as illustrated in FIG. 4.

As described above, according to the present embodiment, an example in which no electrode and wiring are formed in the substrate 11 will be described. However, if an electrode and a wiring are formed in the substrate 11 as a modification example, the electrode is formed in the first substrate preparation process illustrated in FIG. 10. A timing at which the electrode is formed includes various timings. However, the electrode is preferably formed before the first member formation process, from the viewpoint of forming the member PS with high accuracy.

In the second substrate preparation process illustrated in FIG. 10, the TFT substrate corresponding to the substrate 12 illustrated in FIGS. 3 and 4 is prepared. In the second substrate preparation process, the base material 12st composed of a glass substrate, for example, is first prepared (a base material preparation process). After the base material preparation process, the TFT serving as a thin film having a plurality of transistors serving as active elements is formed on one surface of the base material 12st (a TFT formation process).

After the TFT formation process, a wiring electrically connected to the TFT, and the common electrode CE and the pixel electrodes PE illustrated in FIG. 3 are formed (a circuit formation process). The common electrode CE and the pixel electrodes PE are composed of a transparent electrode material such as indium tin oxide (ITO). In the example illustrated in FIG. 3, after the common electrode CE is formed, the insulating layer OC2 is formed to cover the common electrode CE, and the plurality of pixel electrodes PE are further formed on the insulating layer OC2. In this process, the member LA may be formed at a position, which overlaps the member PS in the thickness direction, of the sealing section SL, as illustrated in FIGS. 4 and 6. The member LA is a height adjustment member for adjusting the height of the resin layer OC2 at a position where the member PS is formed. The member LA can be formed of the same material such as ITO as that for the common electrode CE, for example.

If the groove TR1 is formed between the display section DP and the sealing section SL in the substrate 12, as illustrated in FIG. 4, the groove TR1 is formed after the circuit formation process illustrated in FIG. 10, for example (a groove formation process). In this process, a part of the insulating layer OC2 is removed in a direction in which the sealing section SL extends, for example, to form the groove TR1. However, if the member LA is formed in the substrate 12, as illustrated in FIG. 4, the insulating layer OC2 is formed in accordance with a shape of the member LA. Therefore, a position of the groove TR1 and its depth can be adjusted to some extent by adjusting a position where the member LA is formed and its height. If the depth of the groove TR1 can be set to a sufficient depth even if a part of the insulating layer OC2 is not removed, as described above, the groove TR1 can be formed when the insulating layer OC2 is formed. Thus, this process can be omitted.

After the groove formation process, the oriented film AF2 is formed on the side of the front surface 12f of the substrate 12 (an oriented film formation process). In the oriented film formation process, after polyimide resin serving as a raw material for the oriented film AF2, for example, is applied, the oriented film AF2 can be formed by rubbing processing. The rubbing processing may be replaced with a photo-orientation method for irradiating a polymer film with ultraviolet rays and selectively reacting a polymer chain in a polarization direction to form the oriented film AF2.

In a sealing material application process illustrated in FIG. 10, a sealing material SLp illustrated in FIGS. 6 and 11 is applied to surround a periphery of the display section DP in the substrate 11. FIG. 11 is an enlarged sectional view illustrating a sealing material that is applied by being discharged from a nozzle in the sealing material application process illustrated in FIG. 10. FIG. 11 is a sectional view along a line A-A illustrated in FIG. 6. FIG. 11 is an enlarged sectional view illustrating the sealing material SLp that has been applied, in which the nozzle NZ has already moved to another position at the time point where the sealing material SLp has been formed in a shape as illustrated in FIG. 11. However, FIG. 11 illustrates how the sealing material SLp is discharged from the nozzle NZ. Thus, a part of the nozzle NZ and the sealing material SLp discharged from an opening NZk of the nozzle NZ are illustrated as an enlarged side view.

In the sealing material application process, the nozzle NZ is moved along a direction in which the sealing section SL extends while the paste-shaped sealing material SLp is discharged from the nozzle NZ, as illustrated in FIG. 11. In the substrate overlap process illustrated in FIG. 10, an amount of the sealing material SLp, which moves over the member PS in a substrate overlap process, is preferably decreased from the viewpoint of suppressing inhibition of spreading of the sealing material SLp by the member PS. Therefore, in the width direction of the sealing section SL illustrated in FIG. 6 (a direction perpendicular to the direction in which the sealing section SL extends and an X-direction in the example illustrated in FIG. 6), the sealing section SL is preferably arranged so that a center line of the sealing section SL matches the center of the nozzle NZ.

However, considering arrangement accuracy of the nozzle NZ, etc., the center line of the sealing section SL and the center of the nozzle NZ are not easily made to reliably match each other and often shift from each other in position. In an example illustrated in FIG. 11, for example, the opening diameter of the nozzle NZ is approximately 0.4 mm, and position accuracy in the width direction of the nozzle NZ is approximately ±0.1 mm.

When the member PSh linearly extending in the direction in which the sealing section SL extends is formed, like the member PSh described with reference to FIG. 27, therefore, the sealing material SLp may be unable to be applied to both the adjacent sides of the member PSh depending on the position of the nozzle NZ.

On the other hand, the member PS in the present embodiment extends in a zigzag manner in the direction in which the sealing section SL extends. Even if the application position of the sealing material SLp shifts, regions where the sealing material SLp are respectively applied easily occur on both the adjacent sides of the member PS.

In the sealing material application process according to the present embodiment, the sealing material SLp is applied to stride over the member PS in at least a part of the sealing section SL, as described above. Thus, the sealing material SLp is applied on the side of the display section DP with respect to the member PS and on the side of the peripheral edge (the opposite side of the display section DP) with respect to the member PS. In the example illustrated in FIG. 11, a state where the sealing material SLp adheres to the upper surface and both the side surfaces of the member PS is illustrated. However, in a stage of the sealing material application process, a clearance may occur between a side surface of the member PS and the sealing material SLp.

In the liquid crystal supply process illustrated in FIG. 10, a liquid crystal is then dropped so that the display section DP between the substrate 11 and the substrate 12 is filled. In the liquid crystal supply process, a region surrounded by the sealing material SLp illustrated in FIG. 11 is filled with the liquid crystal.

In the substrate overlapping process illustrated in FIG. 10, the substrate 11 and the substrate 12 are overlapped such that the back surface 11b of the substrate 11 and the front surface 12f of the substrate 12 oppose each other, as illustrated in FIG. 3. At this time, the plurality of pixel electrodes PE formed in the substrate 12 and the plurality of color filters CF in the substrate 11 are respectively overlapped so as to oppose each other.

In the substrate overlapping process, either one of the substrate 11 and the substrate 12 is pressed against the other substrate or both the substrates are pressed against each other, in a direction in which the substrates 11 and 12, which are oppositely arranged, come closer to each other. Thus, the sealing material SLp illustrated in FIG. 11 is pushed out toward the both adjacent sides of the member PS.

At this time, in the present embodiment, the member PS is formed in a zigzag manner. Thus, the sealing material SLp easily spreads in a balanced manner to both the adjacent sides of the member PS. Therefore, the sealing material SLp spreads to the entire sealing section SL.

If inhibition of the spreading of the sealing material SLp is thus suppressed, so that the sealing material SLp can spread to the entire sealing section SL, the sealing material SLp and the resin layer OC1 can be made to adhere to each other outside the member PS. Thus, adhesive strength between the substrate 11 and the sealing material SLp is improved. The spreading of the sealing material SLp to the peripheral edge of the substrate 11 can be suppressed.

Local bulge of the sealing material SLp can be suppressed by making it easy for the sealing material SLp to spread. Therefore, a variation in the separation distance between the substrate 11 and the substrate 12 due to insufficient spreading of the sealing material SLp can be suppressed. As a result, the thickness of the liquid crystal layer LCL illustrated in FIG. 4 can be controlled with high accuracy.

In the sealing material hardening process illustrated in FIG. 10, energy is added to the sealing material SLp illustrated in FIG. 3, to harden the sealing material SLp. If the sealing material SLp is hardened, the substrate 11 and the substrate 12 are adhesively fixed to each other via the sealing material SLp. Energy for hardening the sealing material SLp includes heat energy or light energy such as ultraviolet energy.

A method for collectively forming a plurality of products in a large-sized base material and finally individualizing the products is preferable from the viewpoint of improving manufacturing efficiency of the liquid crystal display device LCD1. In this case, in the scribing/breaking process illustrated in FIG. 10, a cutting area of the substrate 11 or the substrate 12 is cut, to individualize the cutting area into a plurality of products. Thus, a contour shape of the liquid crystal display device LCD1 illustrated in FIG. 1 is obtained. At this time, an end surface of the substrate 11 positioned outside the substrate 12 (i.e., a side surface arranged at its peripheral edge) in a plan view is preferably subjected to polishing processing.

In a polarizing plate adhesion process illustrated in FIG. 10, the polarizing plate PL1 and the polarizing plate PL2 illustrated in FIG. 2 are respectively affixed to the front surface 11f of the substrate 11 and the back surface 12b of the substrate 12 via adhesive layers, and they are respectively adhesively fixed to the substrate 11 and the substrate 12.

In the foregoing processes, the liquid crystal display device LCD1 illustrated in FIGS. 3 and 4 is obtained. Then, the obtained liquid crystal display device LCD1 is incorporated into a housing (not illustrated), to complete the display device with the housing. The light source LS illustrated in FIG. 2 can previously be incorporated into the housing.

### MODIFICATION EXAMPLES

Of the modification examples according to the present embodiment described above, representative modification examples will be described below.

### Modification Example 1

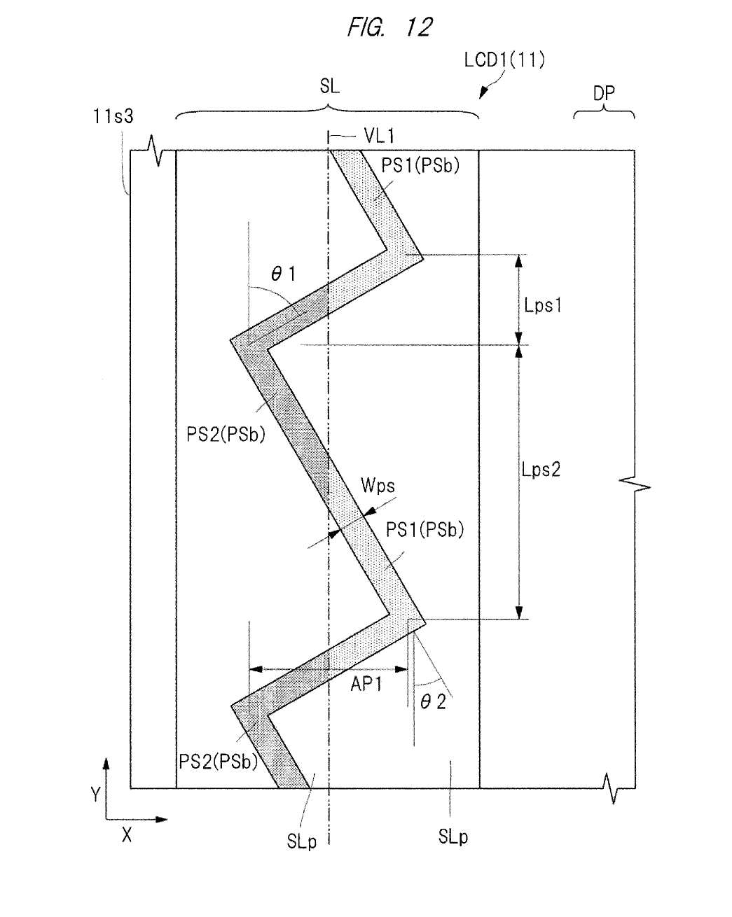

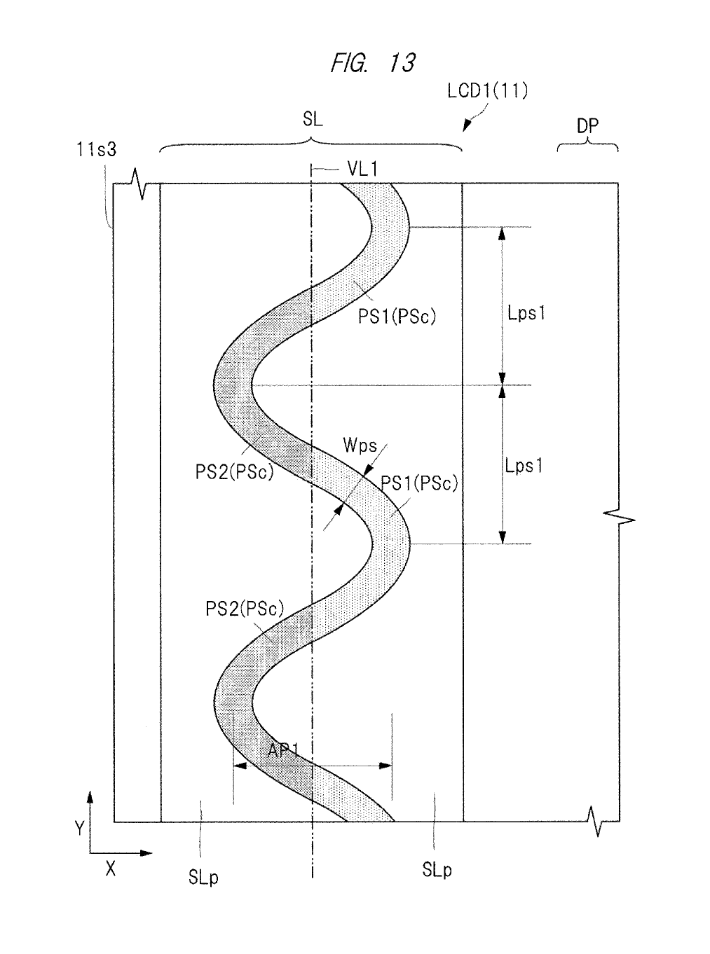

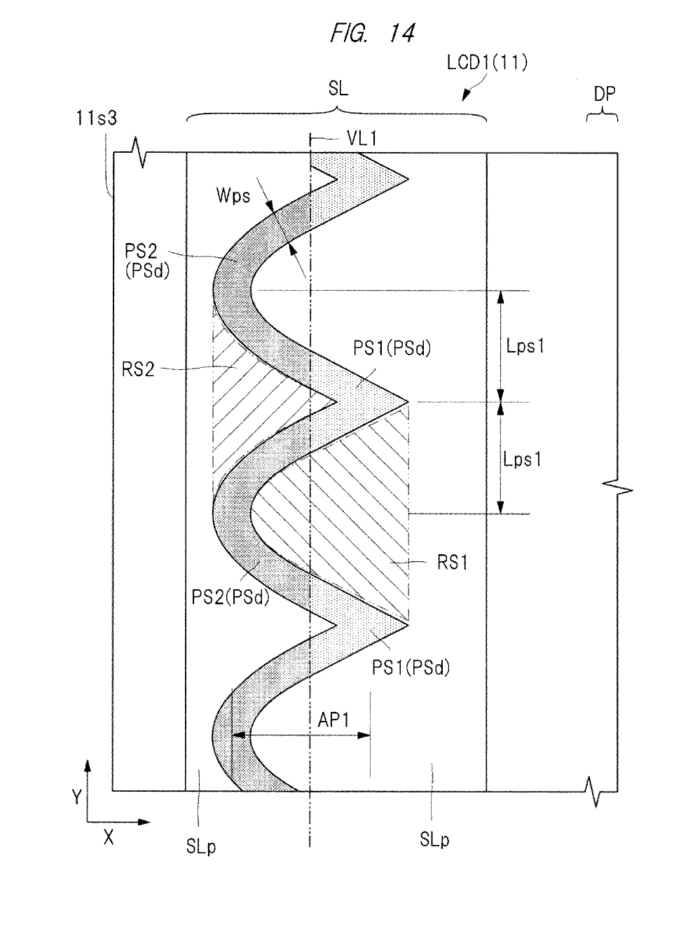

In FIG. 5, an example of the triangular wave shape in which the portions PS1 and the portions PS2, which are line-symmetric with each other, are alternately and continuously arranged with the line VL1 as an axis of symmetry has been described as an example of the zigzag pattern formed by the member PS. However, a shape of the member PS, which makes it easy for the sealing material SLp to spread, includes various modification examples. FIGS. 12 to 15 are enlarged plan views respectively illustrating modification examples of FIG. 5. In FIGS. 14 and 15, to explicitly indicate respective ranges of a region RS1 positioned on the side of a display section DP with respect to a member PSd or PSf and a region RS2 positioned on the side of a peripheral edge of a substrate 11 with respect to the member PSd or PSf within a range of an amplitude of the member PSd or PSf, the region RS1 and the region RS2 are hatched.

For example, a member PSb illustrated in FIG. 12 differs from the member PS illustrated in FIG. 5 in that shapes of a portion PS1 and a portion PS2 are not line-symmetric with each other. In an example illustrated in FIG. 12, a width Wps of the member PSb is 7 μm. An amplitude AP1 of a zigzag pattern is 200 μm with a center line of the member PSb used as a basis. An angle θ1 and an angle θ2 formed between linear parts of the member PSb in a direction in which a sealing section SL extends are respectively 60 degrees and 30 degrees. A spacing LPs1 and a spacing LPs2 between vertices of the portion PS1 and vertices of the portion PS2 in the direction in which the sealing section SL extends are respectively 115 μm and 245 μm.

Even if respective shapes of the portion PS1 and the portion PS2 are not line-symmetric with each other, like in the member PSb, if the zigzag pattern is formed, regions where the sealing material SLp is applied can be respectively provided on both adjacent sides of the member PSb when the sealing material SLp is applied. Therefore, in a substrate overlap process described with reference to FIG. 10, the sealing material SLp can spread in a balanced manner to both the adjacent sides of the member PSb.

Although the member PS illustrated in FIG. 5 is a bent zigzag pattern, the member PS may be a curved zigzag pattern, like a member PSc illustrated in FIG. 13. The member PSc forms a shape of a sine wave or a curved wave shape close to the sine wave in a plan view.

The portion PS1 and the portion PS2 may respectively have asymmetric shapes, like in the member PSd illustrated in FIG. 14. When the portion PS1 and the portion PS2 have asymmetric shapes, like in the member PSd, the area of the region RS1 positioned on the side of the display section DP with respect to the member PSd and the area of the region RS2 positioned on the side of the peripheral edge of the substrate 11 with respect to the member PSd respectively take different values within a range of the amplitude of the member PSd. The region RS1 and the region RS2 are respectively spaces for the sealing material SLp to easily spread in the above-mentioned substrate overlap process. Thus, the sealing material SLp easily spreads toward the region having the relatively larger area.

When the area of the region RS1 is larger than the area of the region RS2, as illustrated in FIG. 14, for example, the sealing material SLp easily spreads toward the display section DP. Thus, when a distance from the sealing section SL to the peripheral edge of the substrate 11 is short, a configuration of the member PSd illustrated in FIG. 14 is preferably used to suppress the spreading of the sealing material SLp to the peripheral edge of the substrate 11.

On the other hand, in order to suppress the spreading of the sealing material SLp to the display section DP because a distance between the sealing section SL and the display section DP is short, the member PSd illustrated in FIG. 14 is preferably arranged in the opposite direction in an X-direction so that the area of the region RS2 becomes larger than the area of the region RS1, for example.

The portion PS1 and the portion PS2 may respectively have rectangular wave shapes forming rectangles, like in the member PSf illustrated in FIG. 15. When the portion PS1 and the portion PS2 have rectangular wave shapes, like in the member PSf, the area of the region RS1 and the area of the region RS2 are easy to control. When the member PSf having the rectangular wave shape is formed, the area of the region RS1 and the area of the region RS2 may take the same value, although illustration is omitted.

In the example illustrated in FIG. 5, the center line in the width direction of the sealing section SL is arranged within the range of the amplitude of the member PS serving as the zigzag pattern. In the example illustrated in FIG. 5, the line VL1 is a center line in the width direction of the sealing section SL and a center line of the amplitude of the member PS. The center line in the width direction of the sealing section SL is preferably arranged within the range of the amplitude of the member PS, as illustrated in FIG. 5, from the viewpoint of spreading the sealing material SLp in a balanced manner to both the adjacent sides of the member PS.

However, as the modification examples, a center line in a width direction of the sealing section SL may be positioned outside ranges of the amplitudes of the member PSd and the member PSf. As in the example illustrated in FIG. 14 and the example illustrated in FIG. 15, for example, a direction in which the sealing material SLp spreads may be controlled, so that the sealing material SLp easily spreads toward either one of the display section DP and the peripheral edge of the substrate 11. In this case, ranges of the amplitudes of the member PSd and the member PSf may be brought closer to the display section DP or the peripheral edge of the substrate 11 in the width direction of the sealing section SL.

In the embodiment illustrated in FIG. 5 and each of the modification examples illustrated in FIGS. 12 to 15, the plurality of portions PS1 having the same shape and the plurality of portions PS2 having the same shape are periodically arrayed along the line VL1. However, the portions PS1 having different shapes and the portions PS2 having different shapes may be arrayed at random along the line VL1. However, the portions PS1 and the portions PS2 are preferably periodically arrayed from the viewpoint of stably controlling the spreading of the sealing material SLp.

### Modification Example 2

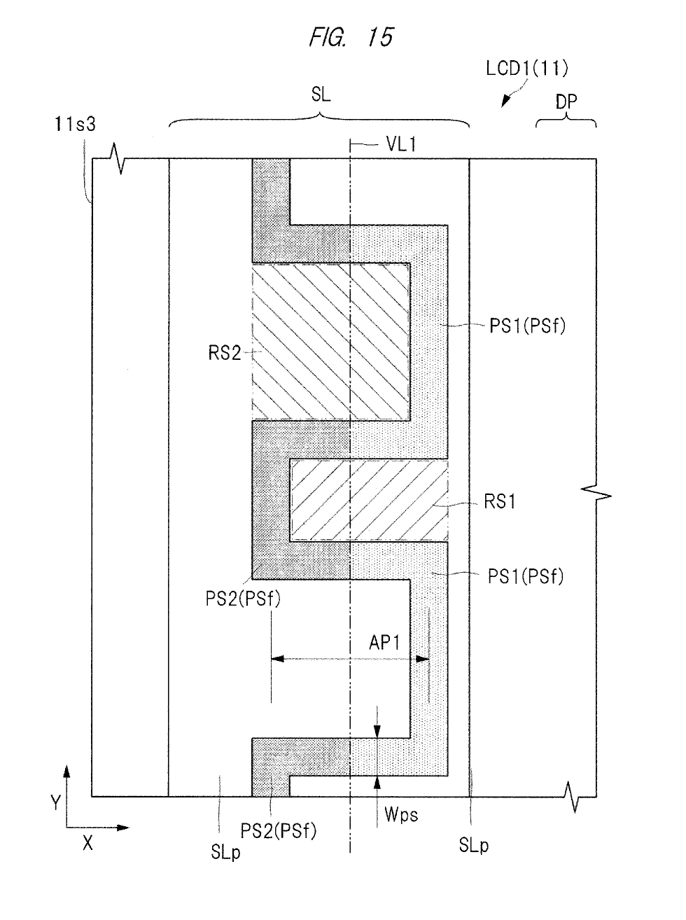

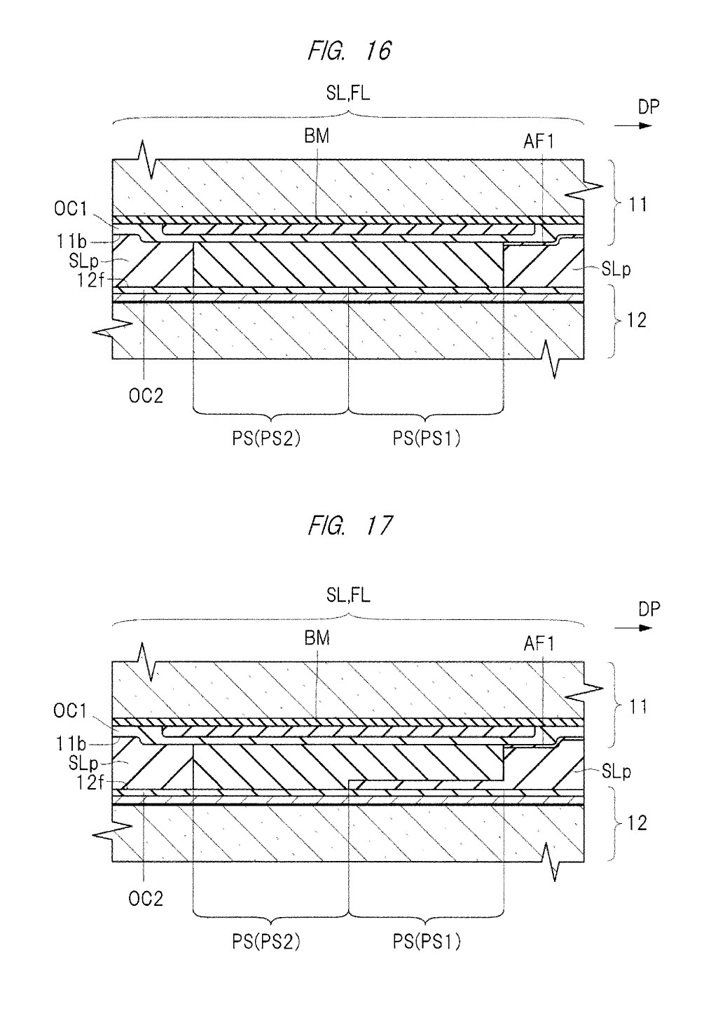

Next, a modification example related to the thickness of the member PS illustrated in FIG. 5 will be described below. FIG. 16 is an enlarged sectional view along the line A-A illustrated in FIG. 5, and FIG. 17 is an enlarged sectional view illustrating a modification example of FIG. 16.

In the example illustrated in FIG. 16, the thickness of the member PS is uniform, for example, approximately 3.0 μm to 4.0 μm. However, as a modification example, the thickness of a portion PS1 and the thickness of a portion PS2 may respectively take different values, as illustrated in FIG. 17. For example, in the example illustrated in FIG. 17, the thickness of a portion PS1 relatively arranged on the side of the display section DP is smaller than the thickness of a portion PS2. In this case, in the substrate overlap process described with reference to FIG. 10, a sealing material SLp easily gets over the portion PS1 in a member PS. That is, the thickness of the member PS is made to take partially different values so that a direction in which the sealing material SLp spreads can be controlled. As a further modification example of FIG. 17, the thickness of the portion PS1 may be larger than the thickness of the portion PS2, although illustration is omitted.

### Modification Example 3

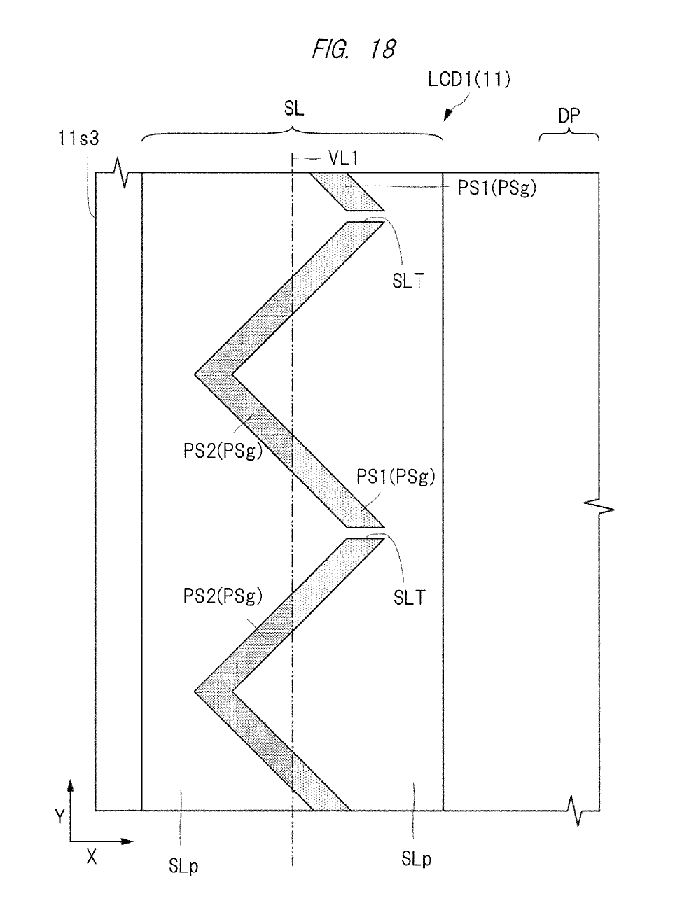

While the member PS described in the above-mentioned embodiment is one member continuously surrounding a periphery of the display section DP, the member PS may include a plurality of members as a modification example. FIGS. 18 to 21 are enlarged plan views respectively illustrating modification examples of FIG. 5.

A member PSg extending in a zigzag manner in a direction in which a sealing section SL extends, as illustrated in FIG. 18, differs from the member PS illustrated in FIG. 5 in that it is divided into a plurality of parts by being provided with a plurality of slits SLT. When the slits SLT are formed, like in the member PSg, a sealing material SLp easily spreads in a site where the slit is formed. For example, in the example illustrated in FIG. 18, the slit SLT is formed in a portion PS1 relatively positioned on the side of a display section DP. In this case, the sealing material SLp easily spreads toward the display section DP. When the slit SLT is formed in a portion PS2, the sealing material SLp easily spreads toward a peripheral edge of a substrate 11, although illustration is omitted.

Even when the slits SLT are formed, like in the member PSg, if the member PSg is formed to intermittently surround a periphery of the display section DP, the member PSg can function as a member for suppressing spreading of an oriented film AF1 (see FIG. 4). However, in order to more reliably damp the spreading of the oriented film AF1, an opening width of the slit SLT is preferably decreased.

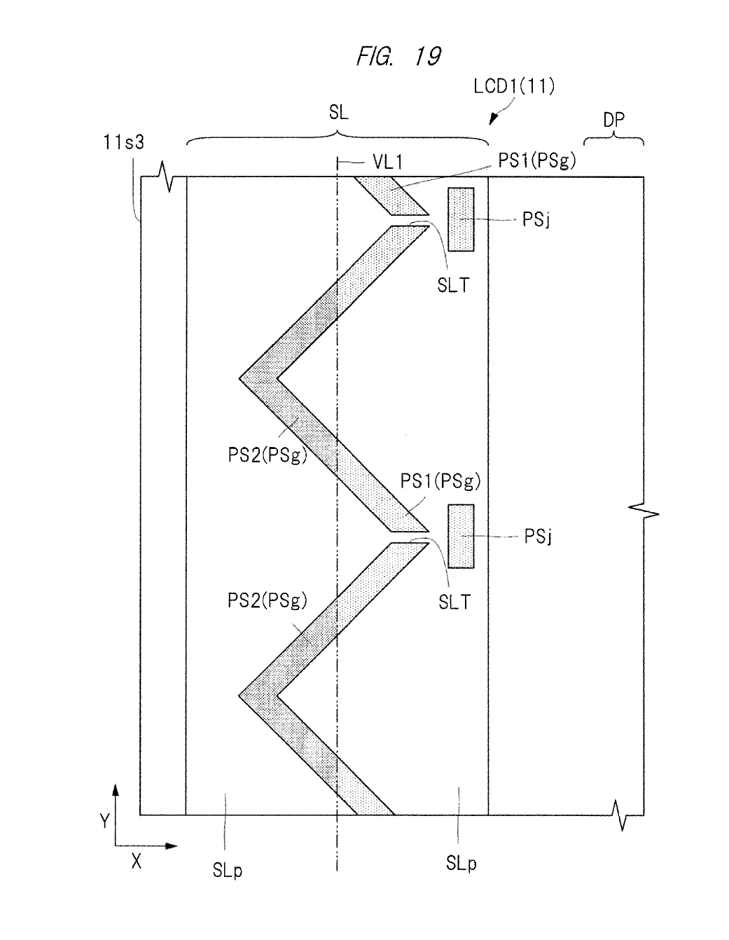

When slits SLT are formed, a member PSj may be formed between a slit SLT and a display section DP to suppress spreading of an oriented film AF1 (see FIG. 4) via the slit SLT, as illustrated in FIG. 19. The member PSj can be formed of the same material as that for a member PSg. While an example in which the member PSj is formed between the slit SLT and the display section DP has been illustrated in FIG. 19, the member PSj may be formed between the slit SLT and a peripheral edge of a substrate 11 as a modification example.

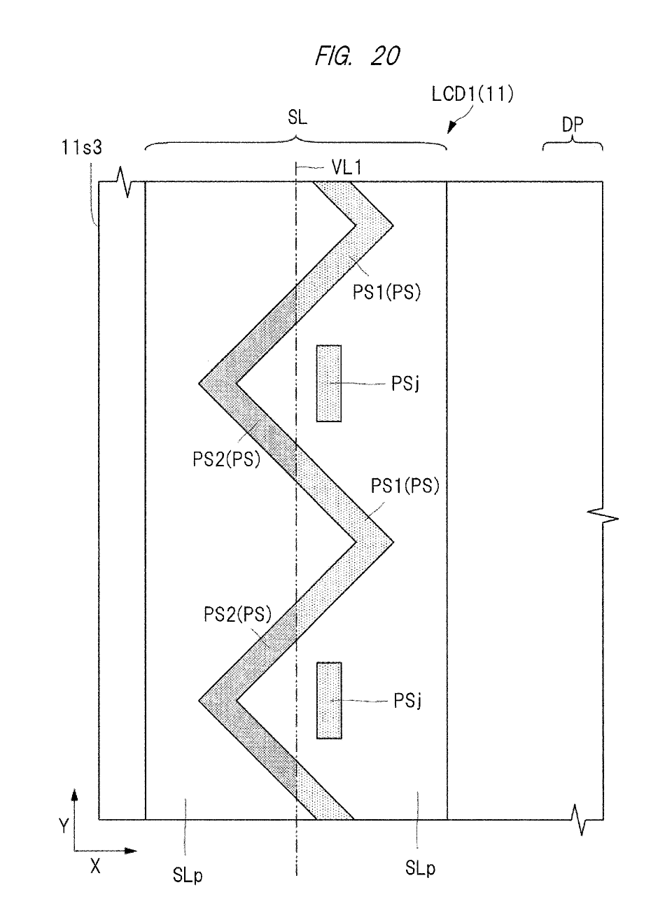

A plurality of members PSj may be arranged between a member PS and a display section DP, like in the modification example illustrated in FIG. 20, from the viewpoint of further reliably damping an oriented film AF1 (see FIG. 4). In the example illustrated in FIG. 20, the plurality of members PSj spaced apart from the member PS are formed between a plurality of portions PS2 in the member PS and the display section DP. Thus, spreading of the oriented film AF1 getting over the portions PS2 in the member PS can be suppressed. While the example in which the members PSj are formed between the portions PS2 and the display section DP has been illustrated in FIG. 20, the members PSj may be formed between the portions PS2 and a peripheral edge of a substrate 11 as a modification example.

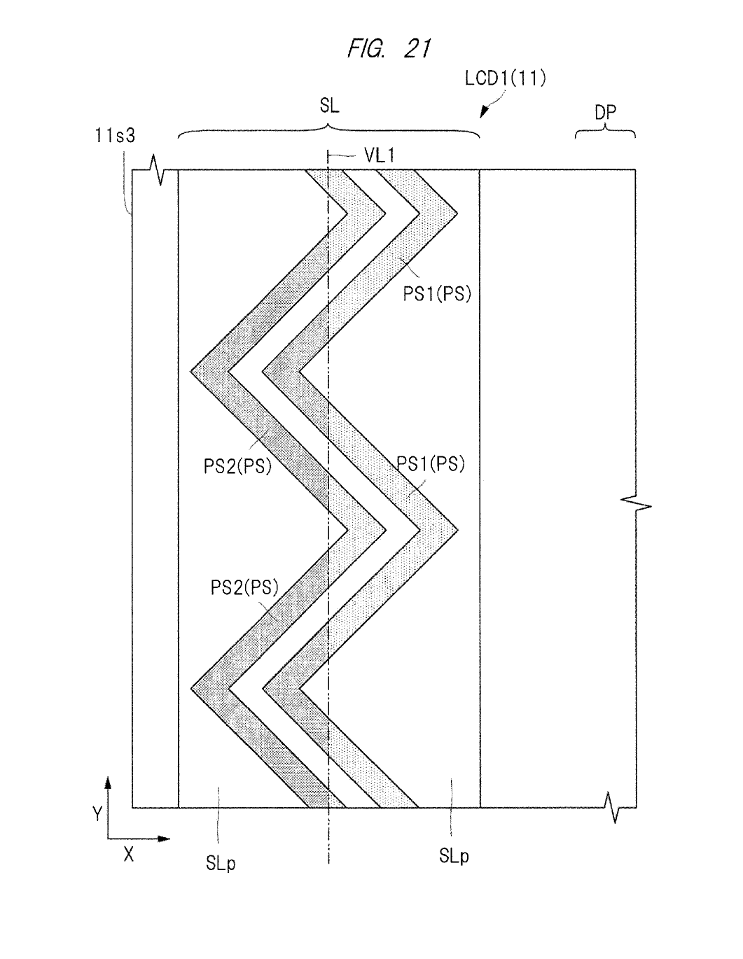

When two members PS are arranged side by side, like in the modification example illustrated in FIG. 21, spreading of an oriented film AF1 toward a peripheral edge of a substrate 11 can be suppressed more reliably than when the plurality of members PSj are partially arranged, like in the modification example illustrated in FIG. 20.

When the plurality of members PS are arranged side by side, as illustrated in FIG. 21, a sealing material SLp is more easily inhibited from spreading than when the one member PS is arranged. Therefore, a center line in a width direction of a sealing section SL is preferably arranged within a range of each of the amplitudes of the plurality of members PS, as illustrated in FIG. 21. In the example illustrated in FIG. 21, a line VL1 is a center line in a width direction of the sealing section SL. Thus, the sealing material SLp can spread in a balanced manner to both adjacent sides of each of the two members PS. One of a plurality of members PS arranged side by side and the other member PS can also be respectively provided on a substrate 11 and a substrate 12.

### Modification Example 4

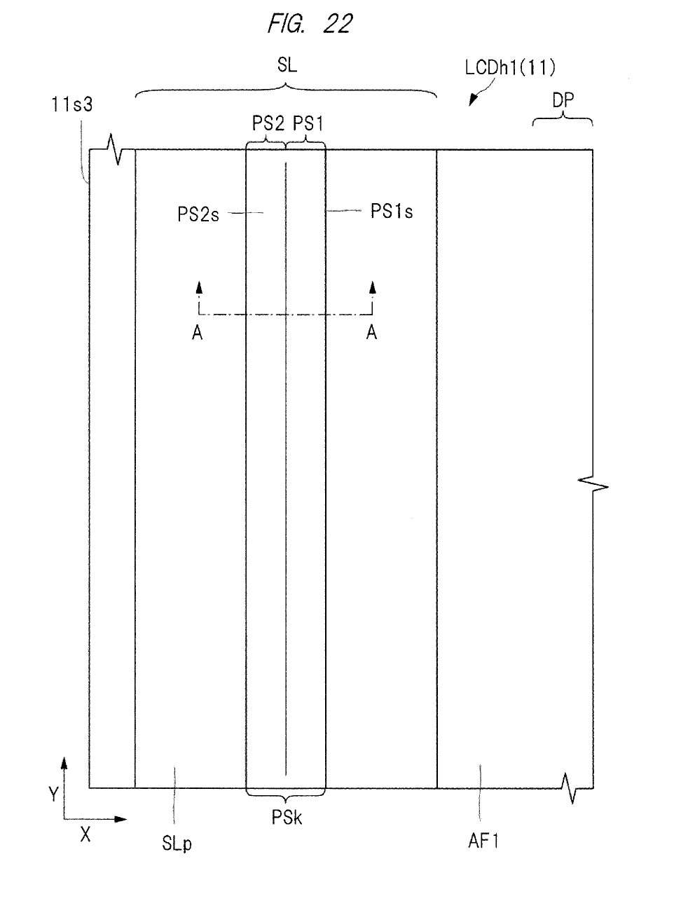

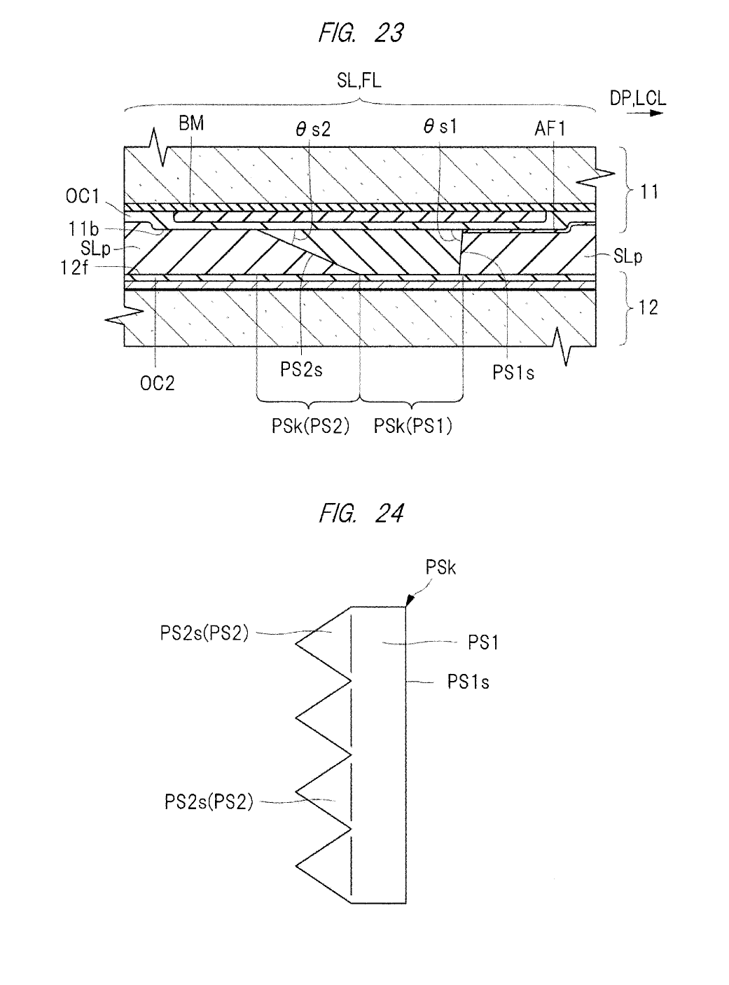

A technique for forming the member PS for damping the oriented film AF1 in a zigzag manner to make it difficult to inhibit the sealing material SLp from spreading has been described in the above-mentioned embodiment and modification examples 1 to 3. In this modification example, a technique for damping an oriented film AF1 and making it difficult to inhibit a sealing material SLp from spreading using a different method from that described above will be described. FIG. 22 is an enlarged plan view illustrating a modification example of FIG. 5. FIG. 23 is an enlarged sectional view along a line A-A illustrated in FIG. 22. FIG. 24 is an enlarged plan view illustrating a modification example of a member for damping an oriented film illustrated in FIG. 22.

A member PSk illustrated in FIGS. 22 and 23 differs from the member PS illustrated in FIG. 5 in that it is not formed in a zigzag manner. In the example illustrated in FIG. 22, the member PSk linearly extends in a direction in which a line VL1 extends.

As illustrated in FIG. 23, the member PSk has a side surface PS1s positioned on the side of a liquid crystal layer LCL (i.e., the side of a display section DP) of the member PSk and inclined with respect to a back surface 11b of a substrate 11, and a side surface PS2s positioned on the opposite side of the side surface PS1s. In the member PSk, a portion PS1 having the side surface PS1s is positioned on the side of the display section DP, and a portion PS2 having the side surface PS2s is positioned on the side of the peripheral edge of the substrate 11.

As illustrated in FIG. 23, an angle θs1 formed between the back surface 11b of the substrate 11 and the side surface PS1s is larger than an angle θs2 formed between the back surface 11b and the side surface PS2s. That is, an angle of inclination of the side surface PS1s to the back surface 11b is steeper than that of the side surface PS2s. In other words, an angle of inclination of the side surface PS2s to the back surface 11b is gentler than that of the side surface PS1s. In the example illustrated in FIG. 23, the angle θs1 is approximately 80 degrees to 85 degrees, and the angle θs2 is approximately 25 degrees to 30 degrees.

The member PSk damps an oriented film AF1 and makes it difficult to inhibit a sealing material SLp from spreading by making the angle of inclination of the side surface PS1s steeper than the angle of inclination of the side surface PS2s. The reason for this will be described below.

First, the oriented film AF1 is easily damped by making the angle θ1s serving as the angle of inclination of the side surface PS1s steeper. Thus, spreading of the oriented film AF1 can be suppressed. The angle θ1s is preferably larger than 45 degrees from the viewpoint of damping the oriented film AF1. The angle of inclination of the side surface PS1s can be easily made steep when the member PSk is formed. When the member PSk is formed through a photolithography process including an exposure process and a removal process for chemically removing its unnecessary part, for example, the angle θ1s is approximately 80 degrees to 90 degrees.

In a substrate overlap process described with reference to FIG. 10, the sealing material SLp easily gets over the member PSk by making the angle θ2s serving as the angle of inclination of the side surface PS2s gentler. As a result, the member PSk makes it difficult to inhibit the sealing material SLp from spreading, and the sealing material SLp easily spreads in a balanced manner to both adjacent sides of the member PSk.

The angle θ2s is preferably 45 degrees or less from the viewpoint of making it easy for the sealing material SLp to get over the member PSk. When the member PSk is formed through the photolithography process, an inclined surface can be formed by performing exposure processing a plurality of times for the side surface PS2s. Alternatively, a plurality of masks, which differ in light transmissivity, are stacked on a region where the member PSk is formed before an exposure process, and the exposure process is then implemented, so that an inclined surface can be formed by performing the exposure process once.

When an inclined surface, like the side surface PS2s, is formed, the member PSk may have a planar shape in which a plurality of portions PS2 each having a side surface PS2s serving as an inclined surface are arrayed in a direction in which a portion PS1 extends, as illustrated in FIG. 24, depending on a value of a resolution limit of an exposure device. If each of the plurality of portions PS2 has the side surface PS2s serving as an inclined surface even in a case illustrated in FIG. 24, however, the sealing material SLp easily gets over the member PSk.

### Modification Example 5

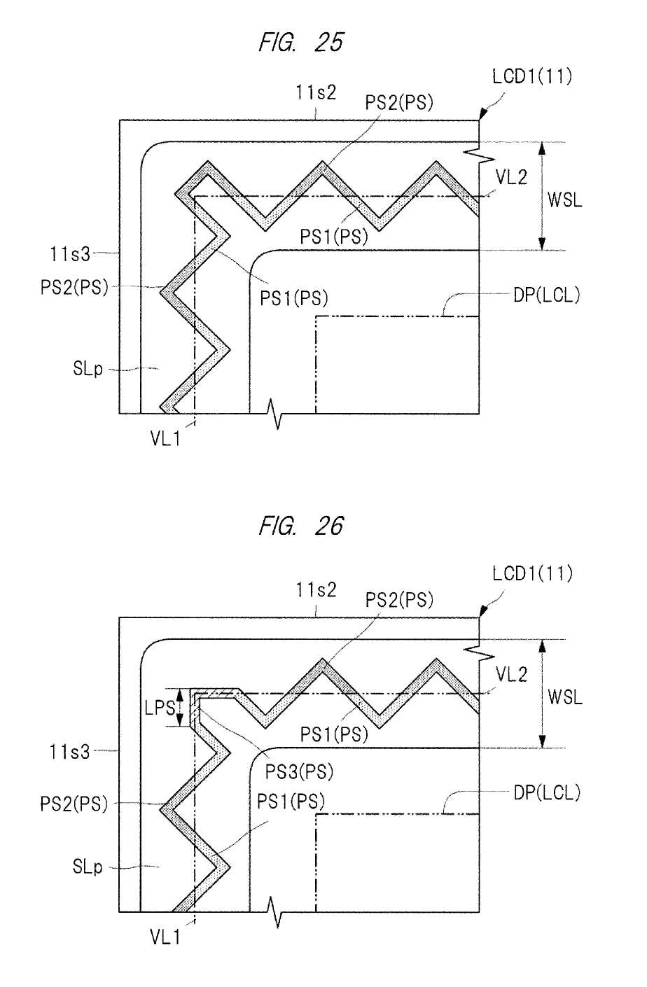

A preferable layout of the member PS illustrated in FIG. 5 will be described below in a corner part of the sealing section SL forming a square in a plan view. FIG. 25 is an enlarged plan view of the portion C illustrated in FIG. 1. FIG. 26 is an enlarged plan view illustrating a modification example of FIG. 25. A line VL2 illustrated in FIGS. 25 and 26 is a virtual line for defining a direction in which a sealing section SL extends, like a line VL1. A member PS extends in a zigzag manner along the line VL1 in a region along a side 11s3, and extends in a zigzag manner along the line VL1 in a region along a side 11s2.

The sealing section SL is provided to continuously surround a periphery of a display section DP where a liquid crystal layer LCL is formed, as illustrated in FIG. 1. When the display section DP forms a square in a plan view, therefore, a planar shape of the sealing section SL also becomes a square.

In this case, considering ease of spreading of a sealing material SLp in a corner part, where the respective sides cross each other, of the sealing section, a zigzag pattern preferably extends to an intersection of the line VL1 along the side 11s3 and the line VL2 serving as the virtual line along the side 11s2, as illustrated in FIG. 25. However, the size of the display section DP and the size of the substrate 11 include various forms for each product. The length of a linear part of the member PS may increase in the corner part depending on an aspect ratio of the display section DP. In this case, the member PS may damp the sealing material SLp in the corner part.

Therefore, as in the modification example illustrated in FIG. 26, a portion PS3 linearly extending along a line VL1 may be connected to an end on the side of a corner part of the member PS. A length LPS, in a direction along the line VL1, of the member PS3 is preferably not more than the half of a width WSL of the sealing section SL. This can suppress inhibition of spreading of a sealing material SLp by the member PS in the corner part of the sealing section SL.

The present invention is not necessarily applied to all of the four sides of the substrate, but it can also be restrictively applied to the sides having a short distance from a display region and an end of the substrate, e.g., only the right and left sides or the right and left sides and the upper side in FIG. 1. Further, the present invention is not necessarily applied to the entire length of the side, but it can also be applied to only a corner part of the side.

In the foregoing, the invention made by the inventors of the present invention has been concretely described based on the embodiments. However, it is needless to say that the present invention is not limited to the foregoing embodiments and various modifications and alterations can be made within the scope of the present invention.

In the category of the idea of the present invention, a person with ordinary skill in the art can conceive various modified examples and revised examples, and such modified examples and revised examples are also deemed to belong to the scope of the present invention. For example, the examples obtained by appropriately making the additions, deletions or design changes of components or the additions, deletions or condition changes of processes to respective embodiments described above by a person with ordinary skill in the art also belong to the scope of the present invention as long as they include the gist of the present invention.

The present invention is applicable to a liquid crystal display device and an electronic apparatus incorporating the liquid crystal display device.

What is claimed is:

1. A liquid crystal display device comprising a first substrate having a first surface, a second substrate having a second surface opposing the first surface of the first substrate, a liquid crystal layer arranged between the first substrate and the second substrate, and a sealing section that is provided along a first virtual line surrounding a periphery of the liquid crystal layer and adhesively fixes the first substrate and the second substrate,
wherein the sealing section includes:
a first member extending in a zigzag manner along the first virtual line; and
a sealing material arranged on both adjacent sides of the first member and continuously surrounding a periphery of the liquid crystal layer.

2. The liquid crystal display device according to claim 1,
wherein the first member includes:
a plurality of first portions positioned on a side of the liquid crystal layer with respect to the first virtual line; and
a plurality of second portions positioned on a side of a peripheral edge of the first substrate with respect to the first virtual line,
the plurality of first portions and the plurality of second portions are alternately arrayed along the first virtual line.

3. The liquid crystal display device according to claim 2,
wherein the plurality of first portions and the plurality of second portions respectively have the same shapes.

4. The liquid crystal display device according to claim 2,
wherein the plurality of first portions and the plurality of second portions are line-symmetric with each other with the first virtual line as an axis of symmetry.

5. The liquid crystal display device according to claim 1,
wherein the first member includes:
a plurality of first potions positioned on a side of the liquid crystal layer with respect to the first virtual line; and
a plurality of second portions positioned on the side of a peripheral edge of the first substrate with respect to the first virtual line,
the plurality of first portions and the plurality of second portions in the first member are continuously connected to each other.

6. The liquid crystal display device according to claim 1,
wherein a center line in a width direction of the sealing section is arranged within a range of an amplitude of the first member serving as a zigzag pattern.

7. The liquid crystal display device according to claim 1,
wherein, within a range of the amplitude of a zigzag pattern formed by the first member, an area of a first region positioned on a side of the liquid crystal layer with respect to the first member and an area of a second region positioned on a side of a peripheral edge of the first substrate with respect to the first member differ from each other.

8. The liquid crystal display device according to claim 1,
wherein the first member includes:
a plurality of first portions positioned on a side of the liquid crystal layer with respect to the first virtual line; and
a plurality of second potions positioned on the side of a peripheral edge of the first substrate with respect to the first virtual line,
a thickness of the plurality of first portions and a thickness of the plurality of second portions differ from each other.

9. The liquid crystal display device according to claim 1,
wherein the sealing section further includes a plurality of second members formed apart from the first member,
the first member includes:
a plurality of first portions positioned on a side of the liquid crystal layer with respect to the first virtual line; and
a plurality of second portions positioned on a side of a peripheral edge of the first substrate with respect to the first virtual line,
the plurality of second members are formed between the plurality of second portions in the first member and a display section where the liquid crystal layer is arranged.

10. The liquid crystal display device according to claim 1,
wherein the sealing section further includes a second member formed apart from the first member and extending in a zigzag manner along the first virtual line,
a center line in a width direction of the sealing section is arranged within a range of an amplitude of each of the first member serving as a zigzag pattern and the second member.

11. The liquid crystal display device according to claim 1,
wherein an oriented film is arranged between the sealing material and the first surface of the first substrate on a side of the liquid crystal layer of the first member.

12. The liquid crystal display device according to claim 1,
wherein the sealing section has a square shape in a plan view, and
the first member extends to a corner part of the sealing section.

13. The liquid crystal display device according to claim 1,
wherein the sealing section has a square shape in a plan view, and
the first member includes:
a plurality of first portions positioned on a side of the liquid crystal layer with respect to the first virtual line;
a plurality of second portions positioned on a side of a peripheral edge of the first substrate with respect to the first virtual line; and
a third portion linearly extending along the first virtual line in a corner part of the sealing section.

14. A liquid crystal display device comprising a first substrate having a first surface, a second substrate having a second surface opposing the first surface of the first substrate, a liquid crystal layer arranged between the first substrate and the second substrate, and a sealing section that is provided along a first virtual line surrounding a periphery of the liquid crystal layer and adhesively fixes the first substrate and the second substrate,
wherein the sealing section includes:
a first member extending along the first virtual line; and
a sealing material arranged on both adjacent sides of the first member and continuously surrounding the periphery of the liquid crystal layer,
the first member has a first side surface positioned on aside of the liquid crystal layer of the first member and inclined with respect to the first surface of the first substrate, and a second side surface positioned on an opposite side of the first side surface, and
a first angle formed between the first surface of the first substrate and the first side surface is larger than a second angle formed between the first surface and the second side surface.

15. The liquid crystal display device according to claim 14,
wherein the second angle is 45 degrees or less.
